(19) United States
(12) Patent Application Publication
(10) Pub. No.: US 2025/0269280 A1
(43) Pub. Date: Aug. 28, 2025

(54) VIRTUAL GAME RESERVATION

(71) Applicant: Tencent Technology (Shenzhen) Company Limited, Shenzhen (CN)

(72) Inventor: Jianfeng LIAN, Shenzhen (CN)

(73) Assignee: Tencent Technology (Shenzhen) Company Limited, Shenzhen (CN)

(21) Appl. No.: 19/207,333

(22) Filed: May 13, 2025

Related U.S. Application Data
(63) Continuation of application No. PCT/CN2023/130244, filed on Nov. 7, 2023.

(30) Foreign Application Priority Data
Feb. 16, 2023 (CN) 202310184820.X

(51) Int. Cl. A63F 13/537

(52) U.S. Cl. CPC A63F 13/537

(57) ABSTRACT

In a virtual game reservation method, a gaming interface corresponding to a first virtual game session that includes a plurality of users is displayed. The gaming interface includes a game reservation control element. Based on a user selection of the game reservation control element in the gaming interface by a first user of the plurality of users, a reservation status control interface on the gaming interface is displayed. The reservation status control interface includes a reservation status indication identifier for each of a subset of the plurality of users. The reservation status indication identifier of each of the subset of the plurality of users indicates whether the respective user intends to participate in a second virtual game session. After the first virtual game session has ended, a game matching interface corresponding to the second virtual game session is displayed. The game matching interface identifies each of the subset of the plurality of users of the first virtual game session that indicated intent to participate in the second virtual game session.

### RELATED APPLICATIONS

The present application is a continuation of International Application No. PCT/CN2023/130244, filed on Nov. 7, 2023, which claims priority to Chinese Patent Application No. 202310184820.X, filed on Feb. 16, 2023. The entire disclosures of the prior applications are hereby incorporated by reference.

### FIELD OF THE TECHNOLOGY

This application relates to the field of computer technologies, including a virtual game reservation method.

### BACKGROUND OF THE DISCLOSURE

In an application program of a battle royale (BR) game including a virtual environment, players participate in a virtual battle through matching, control virtual characters in the virtual environment to battle against each other, and win the current virtual battle when the virtual battle satisfies a specific condition.

For example, in a multiplayer online battle arena (MOBA) game, a player starts a 5V5 virtual battle, and when the player wants to start a next virtual battle with an existing player formation of the virtual battle, after the game ends, the player may trigger a button “another battle” displayed on a settlement page, to invite, through one button, original players of the 5V5 virtual battle to continue to participate in the next virtual battle.

### SUMMARY

Aspects of this disclosure include a virtual battle reservation method, an apparatus, and a non-transitory computer-readable storage medium. Examples of technical solutions of this disclosure may be implemented as follows:

An aspect of this disclosure provides a virtual game reservation method, in which a gaming interface corresponding to a first virtual game session that includes a plurality of users is displayed. The gaming interface includes a game reservation control element. Based on a user selection of the game reservation control element in the gaming interface by a first user of the plurality of users, a reservation status control interface on the gaming interface is displayed. The reservation status control interface includes a reservation status indication identifier for each of a subset of the plurality of users. The reservation status indication identifier of each of the subset of the plurality of users indicates whether the respective user intends to participate in a second virtual game session. After the first virtual game session has ended, a game matching interface corresponding to the second virtual game session is displayed. The game matching interface identifies each of the subset of the plurality of users of the first virtual game session that indicated intent to participate in the second virtual game session.

An aspect of this disclosure provides an apparatus. The apparatus includes processing circuitry configured to display a gaming interface corresponding to a first virtual game session that includes a plurality of users. The gaming interface includes a game reservation control element. Based on a user selection of the game reservation control element in the gaming interface by a first user of the plurality of users, the processing circuitry is configured to display a reservation status control interface on the gaming interface. The reservation status control interface includes a reservation status indication identifier for each of a subset of the plurality of users. The reservation status indication identifier of each of the subset of the plurality of users indicates whether the respective user intends to participate in a second virtual game session. After the first virtual game session has ended, the processing circuitry is configured to display a game matching interface corresponding to the second virtual game session. The game matching interface identifies each of the subset of the plurality of users of the first virtual game session that indicated intent to participate in the second virtual game session.

An aspect of this disclosure provides a non-transitory computer-readable storage medium storing instructions which when executed by a processor cause the processor to perform any of the methods of this disclosure.

In an example a gaming interface includes a battle interface. The battle interface corresponding to the first virtual battle is displayed, a reservation status control is displayed on the battle interface in response to a trigger operation performed on a next battle reservation control, and a battle matching interface corresponding to the second virtual battle including a first user account and a second user account is displayed after the first virtual battle ends. A next virtual battle is reserved with a user account in the current battle on the battle interface of the current battle, thereby avoiding a settlement process, reducing usage time of an entire virtual battle, and improving efficiency of starting a virtual battle.

### BRIEF DESCRIPTION OF THE DRAWINGS

FIG. 1 is a schematic diagram of a virtual battle reservation method according to an aspect of this disclosure;

FIG. 2 is a schematic diagram of an application mode of a virtual battle reservation method according to an aspect of this disclosure;

FIG. 3 is a schematic diagram of an application mode of a virtual battle reservation method according to an aspect of this disclosure;

FIG. 4 is a schematic architectural diagram of a computer system according to an aspect of this disclosure;

FIG. 5 is a flowchart of a virtual battle reservation method according to an aspect of this disclosure;

FIG. 6 is a flowchart of a virtual battle reservation method according to an aspect of this disclosure;

FIG. 7 is a schematic diagram of a battle interface according to an aspect of this disclosure;

FIG. 8 is a schematic diagram of a battle interface of a first client according to an aspect of this disclosure;

FIG. 9 is a schematic diagram of a battle interface of a second client according to an aspect of this disclosure;

FIG. 10 is a schematic diagram of an individual next battle reservation control according to an aspect of this disclosure;

FIG. 11 is a schematic diagram of a battle interface in which next battle reservation succeeds according to an aspect of this disclosure;

FIG. 12 is a schematic diagram of a battle interface in which next battle reservation succeeds according to an aspect of this disclosure;

FIG. 13 is a schematic diagram of a battle matching interface after next battle reservation succeeds according to an aspect of this disclosure;

FIG. 14 is a flowchart of a virtual battle reservation method according to an aspect of this disclosure;

FIG. 15 is a flowchart of a virtual battle reservation method according to an aspect of this disclosure;

FIG. 16 is a flowchart of a virtual battle reservation method according to an aspect of this disclosure;

FIG. 17 is a flowchart of a virtual battle reservation method according to an aspect of this disclosure;

FIG. 18 is a flowchart of initiating reservation by a first client according to an aspect of this disclosure;

FIG. 19 is a flowchart of responding to reservation by a second client according to an aspect of this disclosure;

FIG. 20 is a flowchart of ending reservation according to an aspect of this disclosure;

FIG. 21 is a flowchart of a virtual battle reservation method according to an aspect of this disclosure;

FIG. 22 is a block diagram of a virtual battle reservation apparatus according to an aspect of this disclosure;

FIG. 23 is a block diagram of a virtual battle reservation apparatus according to an aspect of this disclosure;

FIG. 24 is a block diagram of a virtual battle reservation apparatus according to an aspect of this disclosure; and

FIG. 25 is a schematic structural diagram of a computer device according to an aspect of this disclosure.

### DETAILED DESCRIPTION

To make the objectives, technical solutions, and advantages of this disclosure clearer, the following further describes implementations of this disclosure with reference to the accompanying drawings. Examples of aspects are described in detail herein, and examples of the aspects are shown in the accompanying drawings. When the following description involves the accompanying drawings, unless otherwise indicated, the same numerals in different accompanying drawings represent the same or similar elements. The following implementations described in the following aspects do not represent all implementations that are consistent with this disclosure. Instead, they are merely examples according to some aspects of this disclosure.

The terms used in the present disclosure are for the purpose of describing specific aspects only and are not intended to limit the present disclosure. The singular forms of “a” and “the” used in the present disclosure and the appended claims are intended to include the plural forms as well, unless the context indicates otherwise. The term “and/or” used herein indicates and includes any or all possible combinations of one or more associated listed items.

Although the terms such as “first”, “second”, and “third” may be used in the present disclosure to describe various information, the information is not limited to these terms. These terms are merely used to distinguish between information of the same type.

First, terms involved in aspects of this disclosure are briefly introduced. The descriptions of the terms are provided as examples only and are not intended to limit the scope of the disclosure.

Virtual environment: A virtual environment is a virtual environment that an application program displays (or provides) when running on a terminal. The virtual environment may be a simulated environment of the real world, or may be a semi-simulated semi-fictional three-dimensional world, or may be an entirely fictional three-dimensional world. The virtual environment may be any one of a two-dimensional virtual environment, a 2.5-dimensional virtual environment, and a three-dimensional virtual environment. In some aspects, the virtual environment may be further used for a virtual environment battle between at least two virtual characters, and there are virtual resources available to the at least two virtual characters in the virtual environment. In some aspects, the virtual environment includes a lower left corner region and an upper right corner region that are symmetrical, and each of the virtual characters belonging to two enemy camps occupies one of the regions.

Virtual character: A virtual character is a movable object in a virtual environment. The movable object may be at least one of a virtual character, a virtual animal, or a cartoon character. In some aspects, when the virtual environment is a three-dimensional virtual environment, the virtual character can be a three-dimensional virtual model, and each virtual character has a shape and a volume in the three-dimensional virtual environment, and occupies a part of space in the three-dimensional virtual environment. In some aspects, the virtual character is a three-dimensional character built based on a three-dimensional human skeleton technology. The virtual character may show different external images through different skins. In some implementations, the virtual character may be alternatively implemented by using a 2.5-dimensional model or a 2-dimensional model. This is not limited in the aspects of this disclosure.

Multiplayer online battle arena game: A multiplayer online battle arena game may refer to that different virtual teams belonging to at least two different enemy camps occupy respective map regions, and compete with specific victory conditions as goals. The victory condition includes but is not limited to: at least one of occupying a stronghold or destroying a stronghold of an enemy camp, defeating a virtual character in an enemy camp, ensuring survival in a specified scene and time, seizing a specific resource, and outscoring an opponent within a specified time. Tactical competition may be performed by using a battle as a unit, and maps of battles of tactical competition may be the same or may be different. Each virtual team includes one or more virtual characters, for example, 1, 2, 3, or 5.

In response to: “In response to” is used for representing a condition or a state on which an operation to be performed depends. When the dependent condition or state is satisfied, one or more operations may be performed in real time or may have a specified delay. Unless otherwise specified, there is no restriction on the sequence in which multiple operations to be executed are performed.

In a related technology, when a player wants to continue to start a next virtual battle with player formation of an existing virtual battle, the player may trigger, after the game ends, a button “another battle” displayed on a settlement page, and invite a player in the original virtual battle through one click to continue to participate in the next virtual battle. However, after the game ends, a settlement process needs to be performed before the button “another round” is displayed on the settlement interface. In this case, when the button “another round” is triggered to invite player formation in the original virtual battle to continue to start a next virtual battle, it is possible that another player cannot be invited in time and already starts a next new round of battle. Consequently, the player cannot continue to team with a player whom the player wants to team with. As a result, a usage time of an entire virtual battle is further prolonged, and efficiency of starting a virtual battle is relatively low.

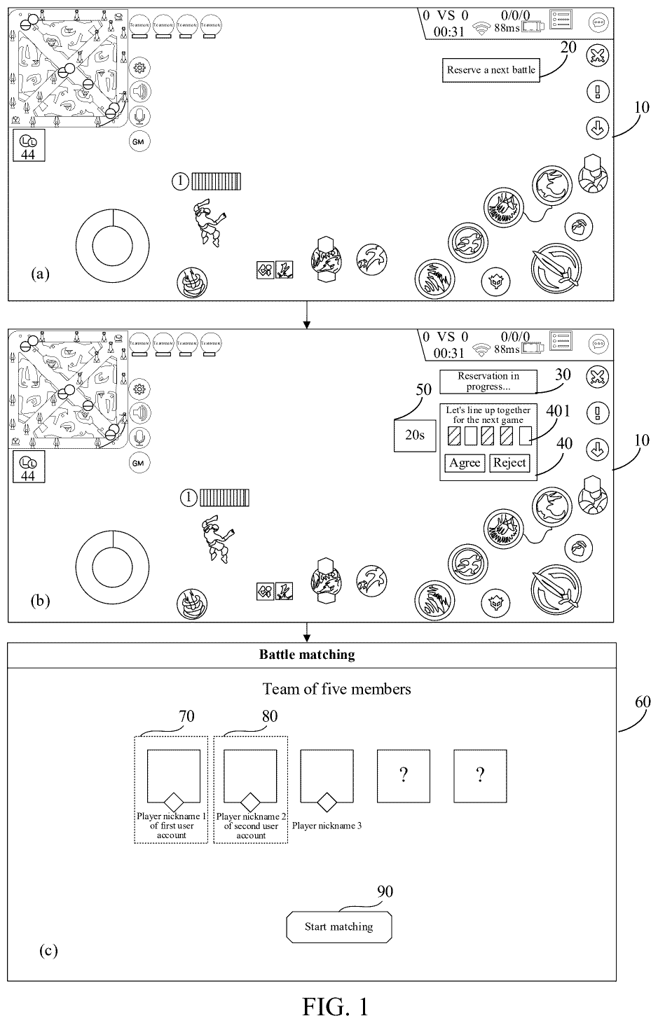

An aspect of this disclosure provides a schematic diagram of a virtual battle reservation method. As shown in FIG. 1, the method is performed by a first client, and a first user account is logged in on the first client.

For example, as shown in (a) of FIG. 1, a battle interface 10 corresponding to a first virtual battle is displayed on the first client. The battle interface 10 displays a next battle reservation control 20. As shown in (b) of FIG. 1, the first client displays a reservation status control 40 on the battle interface 10 in response to a trigger operation performed on the next battle reservation control 20. As shown in (c) of FIG. 1, the first client displays, after the first virtual battle ends, a battle matching interface 60 corresponding to the second virtual battle including a first user account 70 and a second user account 80.

The next battle reservation control 20 is a control (for example, a button) for reserving the second virtual battle with a user account in the first virtual battle.

In some aspects, the user account in the first virtual battle is a user account that belongs to the same team in the first virtual battle, for example, a user account of a teammate. Alternatively, the user account in the first virtual battle is a user account that belongs to a different team in the first virtual battle, for example, a user account of an enemy virtual character.

The reservation status control 40 includes at least one reservation status indication identifier 401, and the reservation status indication identifier 401 is used for indicating willingness representation of a user account to participate in the second virtual battle.

There is a one-to-one correspondence between the reservation status indication identifier 401 and the user account. The second virtual battle is behind the first virtual battle. The reservation status control 40 is displayed in a client corresponding to a user account receiving reservation invitation in the first virtual battle.

In some aspects, a form of the reservation status indication identifier 401 is at least one of an avatar of a virtual character corresponding to a user account, an identifier of a user account, a color box, and a shadow image, but is not limited thereto. This is not specifically limited in this aspect of this disclosure.

The second user account is a user account that is in the first virtual battle and that agrees to participate in the second virtual battle. Because the second user account corresponds to a reservation status indication identifier, and the reservation status indication identifier is used for indicating willingness representation of a corresponding user account to participate in the second virtual battle, the second user account is a user account whose corresponding reservation status indication identifier in the first virtual battle indicates agreeing to participate in the second virtual battle. The agreeing to participate in the second virtual battle is the willingness representation indicated by the reservation status indication identifier corresponding to the second user account. For another user account other than the first user account and the second user account, willingness representation indicated by a reservation status indication identifier corresponding to the another user account may be not agreeing to participate in the second virtual battle.

In some aspects, the second user account is a user account that belongs to the same team or a user account that does not belong to the same team.

The battle matching interface is a team member matching interface corresponding to the second virtual battle, and the battle matching interface is used by the first user account and the second user account to participate in the second virtual battle. When team member matching succeeds, the second virtual battle can be started.

For example, the first user account and the second user account are used as some team members in the same team, and enter the second virtual battle after some other team members in the same team and another team are obtained through matching.

For another example, the first user account and the second user account are all members of the same team, and enter the second virtual battle after another team is obtained through matching.

For another example, the first user account and the second user account are used as team members in different teams, and establishment of the different teams is not completed (a quantity of team members is insufficient and other team members need to be obtained through matching). In this case, the second virtual battle is entered after other team members are obtained through matching to complete establishment of the different teams.

For further example, the first user account and the second user account are used as team members in different teams, and establishment of the different teams is completed (a quantity of team members is sufficient and other team members do not need to be obtained through matching). In this case, the second virtual battle is directly entered on the battle matching interface without matching other team members.

For example, the first client displays, in response to the trigger operation performed on the next battle reservation control 20, the reservation status control 40 with the first user account 70 as a reservation initiator in a case that the first user account is an initiating account that triggers the next battle reservation control 20.

In some aspects, the first client displays, in the reservation status control 40 with the first user account as the reservation initiator in response to the trigger operation performed on the next battle reservation control 20 and in the case that the first user account is an initiating account that triggers the next battle reservation control 20 in the same team, a reservation status indication identifier 401 corresponding to a user account that is in the same team and that agrees to participate in the second virtual battle.

In some aspects, the first client sends a next battle reservation request to a server in response to the trigger operation performed on the next battle reservation control 20. The server is configured to synchronize the next battle reservation request to a client corresponding to another user account in the same team, and place the first user account into a reservation pool as the reservation initiator; and the reservation pool is configured for temporarily storing a user account that is in the first virtual battle and that agrees to participate in the second virtual battle.

The first client displays, in the reservation status control 40 based on information about the user account in the reservation pool that is fed back by the server, the reservation status indication identifier 401 corresponding to the user account that agrees to participate in the second virtual battle.

In an example, the first client displays, in the reservation status control 40 in response to the trigger operation performed on the next battle reservation control 20 and in a case that the first user account triggers the next battle reservation control in a specified manner, a reservation status indication identifier 401 corresponding to a user account that is of user accounts invited for reservation in a specified manner and that agrees to participate in the second virtual battle.

In some aspects, the first client sends the next battle reservation request to the server in a specified manner in response to a specified trigger operation performed on the next battle reservation control 20. The server is configured to synchronize the specified next battle reservation request to a client corresponding to a user account invited for reservation in a specified manner in the first virtual battle, and place the first user account into a reservation pool as the reservation initiator.

The first client displays, in the reservation status control 40 based on information about the user account in the reservation pool that is fed back by the server, the reservation status indication identifier 401 corresponding to the user account that is of the user accounts invited for reservation in a specified manner and that agrees to participate in the second virtual battle.

In some aspects, the next battle reservation control further includes an individual next battle reservation control. There is a one-to-one correspondence between the individual next battle reservation control and the user account. The first client sends a specified next battle reservation request to the server in response to a specified trigger operation performed on the individual next battle reservation control. The specified trigger operation performed on the individual next battle reservation control may be a specified trigger operation performed on an individual next battle reservation control corresponding to only one user account, or may be a batch specified trigger operation performed on individual next battle reservation controls corresponding to multiple user accounts. The multiple user accounts may be some of user accounts of all user accounts participating in the first virtual battle other than the first user account.

The specified next battle reservation request is configured for requesting a user account corresponding to the individual next battle reservation control to participate in the second virtual battle; and the server is configured to synchronize the specified next battle reservation request to the client corresponding to the user account invited for reservation in a specified manner in the first virtual battle.

For example, in a game battle, the first user account initiates the next battle reservation request to only some user accounts by triggering the next battle reservation control 20. For example, if the first user account initiates the next battle reservation request to a user account corresponding to an enemy virtual character, the reservation status control 40 with the first user account as the reservation initiator is only displayed in a client corresponding to the user account of the enemy virtual character receiving the reservation invitation in the first virtual battle, that is, the reservation status control 40 is not displayed in a client corresponding to another user account not receiving the reservation invitation.

In an example, the first client dynamically displays, in the reservation status control in response to the trigger operation performed on the next battle reservation control, the reservation status indication identifier corresponding to the user account that agrees to participate in the second virtual battle.

In some aspects, a manner of dynamically displaying the reservation status control includes: at least one of always displaying the reservation status control on the battle interface, or intermittently displaying the reservation status control on the battle interface, but is not limited thereto. This is not specifically limited in this aspect of this disclosure.

For example, display of the reservation status control 40 with the first user account as the reservation initiator is canceled in a case that the reservation status control 40 satisfies a display cancellation condition.

In some aspects, display of the reservation status control 40 with the first user account as the reservation initiator is canceled in a case that all user accounts receiving next battle reservation invitation agree to participate in the second virtual battle. Alternatively, display of the reservation status control 40 with the first user account as the reservation initiator is canceled in a case that all user accounts receiving next battle reservation invitation do not agree to participate in the second virtual battle. For example, after display of the reservation status control 40 with the first user account as the reservation initiator is canceled, a result indication identifier may be displayed. A first state of the result indication identifier is used for indicating that all user accounts receiving the next battle reservation invitation agree to participate in the second virtual battle. A second state of the result indication identifier is used for indicating that all user accounts receiving the next battle reservation invitation do not agree to participate in the second virtual battle. The first state and the second state are different states. The first state and the second state are not limited in this aspect of this disclosure. The result indication identifier is used for prompting an invitation result of inviting a player in the first virtual battle to continue to participate in the second virtual battle, to avoid forgetting the invitation result in a subsequent game process.

In some aspects, a countdown identifier 50 is displayed on the battle interface, and display of the reservation status control 40 with the first user account as the reservation initiator is canceled in a case that at least one user account receiving next battle reservation invitation does not agree to participate in the second virtual battle and a display duration of the reservation status control 40 reaches a time threshold, for example, the countdown identifier 50 is reset to zero. For example, if a user account receiving next battle reservation invitation does not determine, within a reference time, whether to agree to participate in the second virtual battle, it may be defaulted that the user account does not agree to participate in the second virtual battle. The reference time may be less than or equal to the time threshold. This is not limited herein.

For example, when the next battle reservation control 20 is triggered, the battle interface 10 displays the reservation status control 40 with the first user account 70 as the reservation initiator, and a display time of the reservation status control 40 is 20 s. When all user accounts in the same team agree to participate in the second virtual battle, display of the reservation status control 40 with the first user account as the reservation initiator is canceled. For example, when the countdown identifier 50 is 10 s, all user accounts in the same team agree to participate in the second virtual battle, and display of the reservation status control 40 and the countdown identifier 50 is directly canceled. Alternatively, display of the reservation status control 40 with the first user account as the reservation initiator is canceled in a case that at least one user account in the same team does not agree to participate in the second virtual battle and the countdown identifier 50 is reset to 0.

In some aspects, the battle interface further displays a reservation in-process control 30, and the first client switches the next battle reservation control 20 to the reservation in-process control 30 on the battle interface 10 in response to the trigger operation performed on the next battle reservation control 20; where

the reservation in-process control 30 is configured for ending or modifying the current reservation operation.

For example, the first client directly displays, after the first virtual battle ends and in a case that the reservation operation for the second virtual battle succeeds, the battle matching interface 60 corresponding to the second virtual battle including the first user account and the second user account.

In some aspects, the first client directly displays, after the first virtual battle ends and in a case that a quantity of user accounts that are in the same team and that agree to participate in the second virtual battle is greater than a quantity threshold, the battle matching interface 60 corresponding to the second virtual battle including the first user account and the second user account.

For example, when the same team includes five user accounts, and a quantity of user accounts that are of the five user accounts and that agree to participate in the second virtual battle is greater than three, the reservation operation for the second virtual battle succeeds. As shown in (c) of FIG. 1, the battle matching interface 60 corresponding to the second virtual battle displays the first user account as the reservation initiator and the second user account that agrees to participate in the second virtual battle, and the first client starts the second virtual battle in response to a trigger operation performed on a start matching control 90.

In some aspects, when all user accounts in the same team agree to participate in the second virtual battle, the first client directly starts the second virtual battle in response to the trigger operation performed on the start matching control 90.

In some aspects, when not all the user accounts in the same team agree to participate in the second virtual battle, after the trigger operation performed on the start matching control 90, the first client establishes a team based on the first user account and the second user account that agrees to participate in the second virtual battle, and starts the second virtual battle after a small team of five persons is established.

For example, the first client displays a battle settlement interface of the first virtual battle after the first virtual battle ends and in a case that the reservation operation for the second virtual battle fails.

In conclusion, according to the method provided in this aspect, a battle interface corresponding to a first virtual battle is displayed, a reservation status control is displayed on the battle interface in response to a trigger operation performed on a next battle reservation control, and a battle matching interface corresponding to the second virtual battle including a first user account and a second user account is displayed after the first virtual battle ends. In this disclosure, a next virtual battle is reserved with a user account in the current battle on the battle interface of the current battle, thereby avoiding a settlement process, reducing usage time of an entire virtual battle, and improving efficiency of starting a virtual battle.

The aspects of this disclosure provide a virtual battle reservation method and apparatus, a device, a storage medium, and a program product, which can more flexibly and concisely reserve a virtual battle in a virtual scene and improve the efficiency and user experience of human-computer interaction. For ease of understanding the virtual battle reservation method provided by the aspects of this disclosure, an implementation scenario of the virtual battle reservation method provided by the aspects of this disclosure is first described. A virtual scene in the virtual battle reservation method provided by the aspects of this disclosure can be outputted based on a client device, or based on the collaboration of a client device and a server.

In some aspects, the virtual scene can be an environment for virtual objects (such as target virtual objects) to interact, for example, can be used for a game character to battle. By controlling actions of game characters, the two parties can interact in the virtual scene, thus enabling users to relieve life stress during the game.

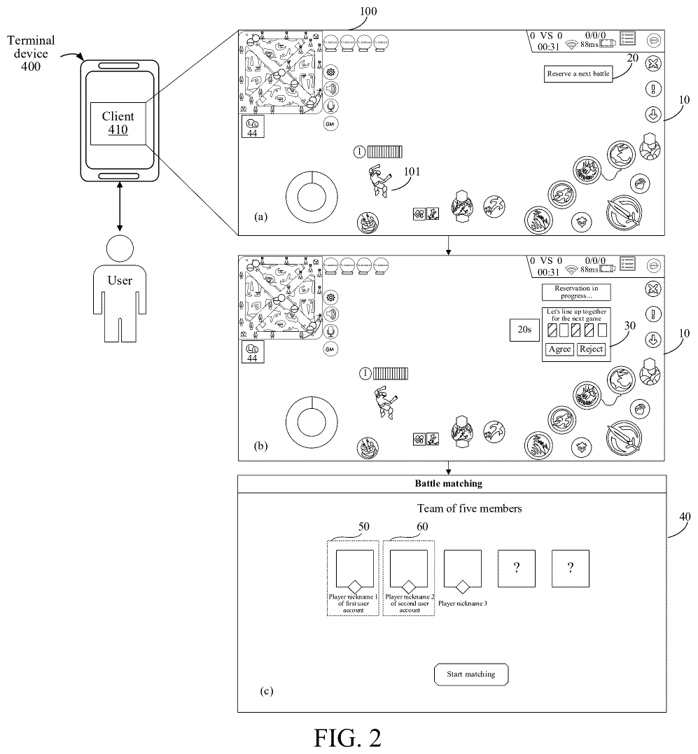

In an implementation scenario, FIG. 2 is a schematic diagram of an application mode of a virtual battle reservation method according to an aspect of this disclosure. The method is suitable for some application modes in which related data of a virtual scene 100 can be calculated based on computing power of graphics processing hardware of a terminal device 400, such as stand-alone/offline-mode games. The virtual scene can be outputted through various different types of terminal devices 400 such as smartphones, tablet computers, and virtual reality/augmented reality devices.

For example, a type of the graphics processing hardware includes processing circuitry, such as a central processing unit (CPU) and a graphics processing unit (GPU).

When forming visual perception of the virtual scene 100, the terminal device 400 calculates, through the graphics computing hardware, data required for display, completes loading, parsing, and rendering of the display data, and outputs, through graphics output hardware, video frames capable of forming visual perception of the virtual scene, for example, presents two-dimensional video frames on a display screen of a smartphone, or projects video frames on lenses of augmented reality/virtual reality glasses to achieve a three-dimensional display effect. In addition, to enrich the perception effect, the terminal device 400 can also use different hardware to form one or more of auditory perception, tactile perception, motion perception, and taste perception.

As an example, the terminal device 400 runs a client 410 (for example, a stand-alone game application). During the running process of the client 410, a virtual scene including character-playing is outputted. The virtual scene may be an environment for game characters to interact, for example, can be plains, streets, and valleys for game characters to battle. For example, the virtual scene 100 is displayed from the third-person perspective. A control virtual character 101 is displayed in the virtual scene 100. The control virtual character 101 can be a game character controlled by a user. That is, the control virtual character 101 is controlled by a real user and moves in the virtual scene 100 in response to an operation performed by the real user on a controller (such as a touch screen, a voice-activated switch, a keyboard, a mouse, or a joystick). For example, when the real user moves the joystick (including a virtual joystick and a real joystick) to the right, the control virtual character 101 can move to the right in the virtual scene 100 or can stay still or jump, or the control virtual character 101 is controlled to perform shooting operations.

For example, a battle interface 10 (including the virtual scene 100) corresponding to a first virtual battle is displayed on the client 410. The battle interface 10 displays a next battle reservation control 20. A reservation status control 30 is displayed on the battle interface 10 in response to a trigger operation performed on the next battle reservation control 20. In response to the end of the first virtual battle, a battle matching interface 40 corresponding to the second virtual battle including a first user account 50 and a second user account 60 is displayed. A next virtual battle is reserved with a user account in the current battle on the battle interface of the current battle, thereby avoiding a settlement process, reducing usage time of an entire virtual battle, and improving efficiency of starting a virtual battle.

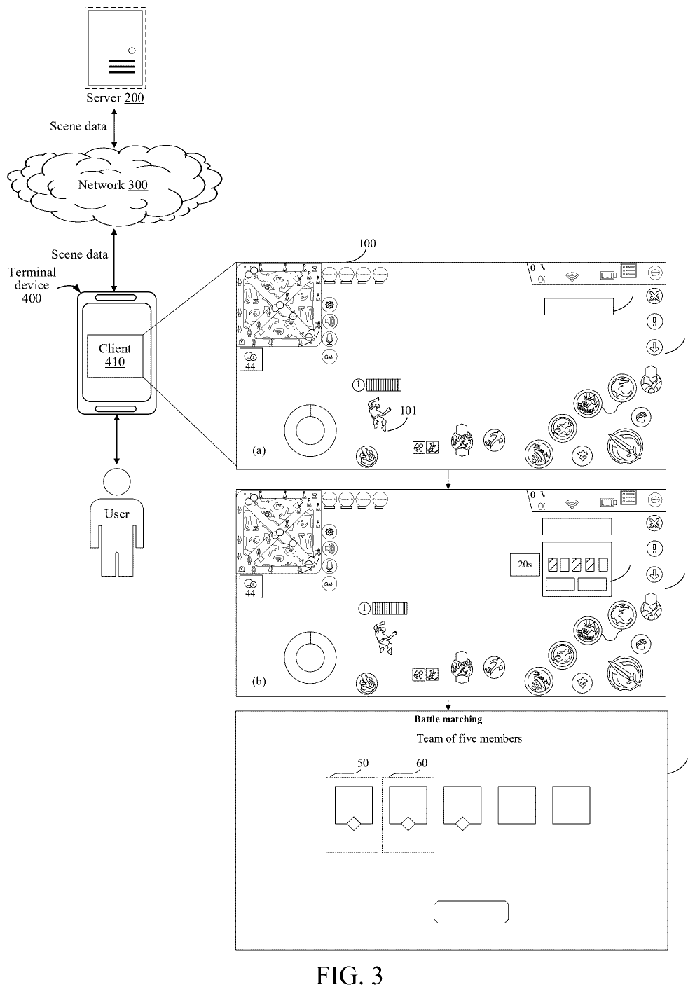

In another implementation scenario, FIG. 3 is a schematic diagram of an application mode of a virtual battle reservation method according to an aspect of this disclosure. The method is applied to the terminal device 400 and the server 200 and is suitable for an application mode in which virtual scene calculation is completed based on computing power of the server 200 and the terminal device 400 outputs a virtual scene.

For example, visual perception of the virtual scene 100 is formed. The server 200 calculates related display data (such as scene data) of the virtual scene and sends the data to the terminal device 400 through a network 300. The terminal device 400 completes loading, parsing, and rendering of the calculated display data through graphics computing hardware, and outputs the virtual scene through graphics output hardware to form visual perception, for example, may present two-dimensional video frames on the display screen of a smartphone, or project video frames on lenses of augmented reality/virtual reality glasses to achieve a three-dimensional display effect. For the perception of the form of the virtual scene, corresponding hardware output of the terminal device 400 can be used, for example, a microphone is used to form auditory perception, or a vibrator is used to form tactile perception.

As an example, the terminal device 400 runs a client 410 (for example, a network game application), and interacts with other users by connecting to the server 200 (for example, a game server). The terminal device 400 outputs the virtual scene 100 of the client 410. For example, the virtual scene 100 is displayed from the third-person perspective. A control virtual character 101 is displayed in the virtual scene 100. The control virtual character 101 can be a game character controlled by a user. That is, the control virtual character 101 is controlled by a real user and moves in the virtual scene 100 in response to an operation performed by the real user on a controller (such as a touch screen, a voice-activated switch, a keyboard, a mouse, or a joystick). For example, when the real user moves the joystick to the right, the control virtual character 101 can move to the right in the virtual scene 100 or can stay still or jump, or the control virtual character 101 is controlled to perform shooting operations.

For example, a battle interface 10 (including the virtual scene 100) corresponding to a first virtual battle is displayed on the client 410. The battle interface 10 displays a next battle reservation control 20. A reservation status control 30 is displayed on the battle interface 10 in response to a trigger operation performed on the next battle reservation control 20. In response to the end of the first virtual battle, a battle matching interface 40 corresponding to the second virtual battle including a first user account 50 and a second user account 60 is displayed. A next virtual battle is reserved with a user account in the current battle on the battle interface of the current battle, thereby avoiding a settlement process, reducing usage time of an entire virtual battle, and improving efficiency of starting a virtual battle.

In some aspects, the terminal device 400 can also implement, by running a computer program, the virtual battle reservation method provided by the aspects of this disclosure. For example, the computer program can be a native program or software module in an operating system, can be a native application program, that is, a program that needs to be installed in the operating system to run, such as a shooting game APP (that is, the client 410), can be a mini program, that is, a program that only needs to be downloaded to a browser environment to run; or can be a game mini program that can be embedded in any APP. In conclusion, the computer program can be any form of application program, module, or plug-in.

For example, the computer program is an application program, and the terminal device 400 installs and runs an application program that supports virtual scenes. The application program can be any one of a first-person shooting game (FPS), a third-person shooting game, a virtual reality application program, and a three-dimensional map program. A user uses the terminal device 400 to operate a virtual object in the virtual scene to perform activities. The activities include but are not limited to: at least one of adjusting the body posture, crawling, walking, running, riding, jumping, driving, picking up, throwing, and building a virtual architecture. In an example, the virtual object may be a virtual character, such as a simulated character or an animation character.

In some other aspects, the aspects of this disclosure may be implemented by a cloud technology. The cloud technology is a hosting technology that unifies a series of resources such as hardware, software, and networks in a wide area network or a local area network to implement computing, storage, processing, and sharing of data.

The cloud technology is a general term for a network technology, an information technology, an integration technology, a management platform technology, an application technology, and the like applied based on the business mode of cloud computing, and may form a resource pool used on demand flexibly and conveniently. The cloud computing technology will become an important support. A background service of a technical network system requires a large amount of computing and storage resources.

For example, the server 200 in FIG. 3 can be an independent physical server, or a server cluster including multiple physical servers, or a distributed system, and can also be a cloud server that provides basic cloud computing services such as cloud services, cloud databases, cloud computing, cloud functions, cloud storage, network services, cloud communications, middleware services, domain name services, security services, and big data and artificial intelligence platforms. The terminal device 400 may be a smartphone, a tablet computer, a notebook computer, a desktop computer, a smart speaker, a smartwatch, or the like, but is not limited thereto. The terminal device 400 and the server 200 may be directly or indirectly connected in a wired or wireless communication protocol. This is not limited in the aspects of this disclosure.

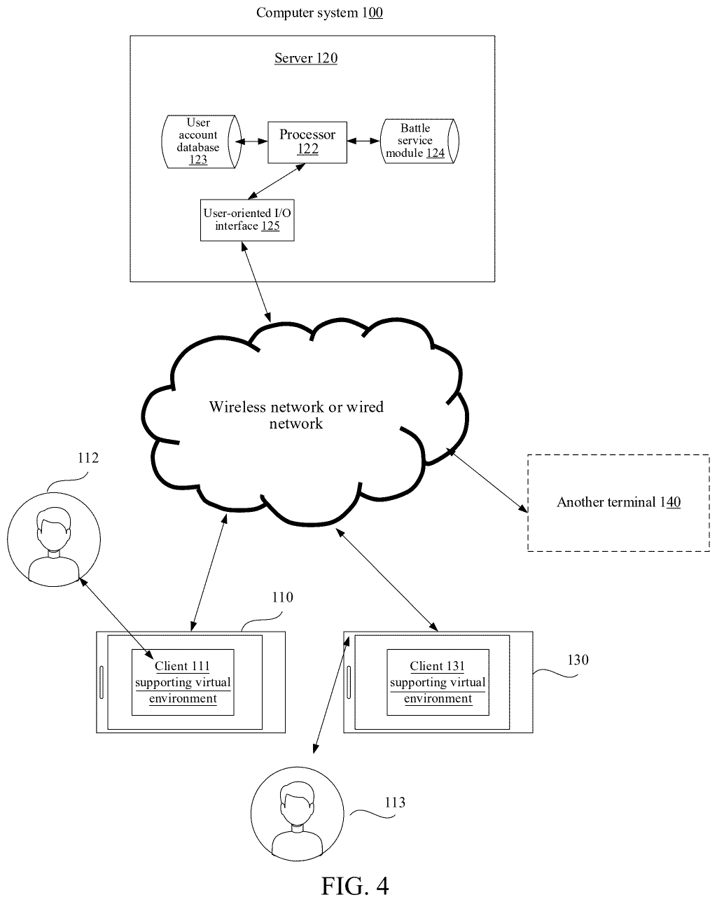

FIG. 4 is a structural block diagram of a computer system according to an aspect of this disclosure. The computer system 100 includes: a first terminal 110, a server 120, and a second terminal 130.

A client 111 that supports a virtual environment is installed and run on the first terminal 110. The client 111 may be a multiplayer online battle program. When the first terminal runs the client 111, a user interface of the client 111 is displayed on the screen of the first terminal 110. The client 111 may be any one of a battle royale shooting game, a virtual reality (VR) application program, an augmented reality (AR) program, a three-dimensional map program, a virtual reality game, an augmented reality game, a first-person shooting game (FPS), a third-individual shooting game (TPS), a multiplayer online battle arena game (MOBA), or a simulation game (SLG). In this aspect, for example, the client 111 is a shooting game. The first terminal 110 is a terminal used by a first user 112. The first user 112 uses the first terminal 110 to control a first virtual character in a virtual environment to perform an activity, or operate a virtual item owned by a second virtual character. The first virtual character may be referred to as a virtual character of the first user 112. The first user 112 may perform operations such as assembling, disassembling, and unloading on a virtual item owned by the first virtual character. This is not limited in this disclosure. In an example, the first virtual character is a simulated character or an animation character.

A client 131 that supports a virtual environment is installed and run on the second terminal 130. The client 131 may be a multiplayer online battle program. When the second terminal 130 runs the client 131, a user interface of the client 131 is displayed on the screen of the second terminal 130. The client may be any one of a battle royale shooting game, a VR application program, an AR program, a three-dimensional map program, a virtual reality game, an augmented reality game, an FPS, a TPS, a MOBA, or an SLG. In this aspect, for example, the client is an MOBA game. The second terminal 130 is a terminal used by a second user 113. The second user 113 uses the second terminal 130 to control a second virtual character in a virtual environment to perform an activity, or operate a virtual item owned by the second virtual character. The second virtual character may be referred to as a virtual character of the second user 113. In an example, the second virtual character is a simulated character or an animation character.

In some aspects, the first virtual character and the second virtual character are in the same virtual environment. In some aspects, the first virtual character and the second virtual character may belong to the same camp, the same team, the same organization, have a friend relationship, or have temporary communication permission. In some aspects, the first virtual character and the second virtual character may belong to different camps, different teams, or different organizations, or have a hostile relationship with each other.

In some aspects, the clients installed on the first terminal 110 and the second terminal 130 are the same, or the clients installed on the two terminals are the same type of clients on different operating system platforms (Android or IOS). The first terminal 110 may refer to one terminal of a plurality of terminals, and the second terminal 130 may refer to another terminal of the plurality of terminals. This aspect only uses the first terminal 110 and the second terminal 130 as an example. Device types of the first terminal 110 and the second terminal 130 are the same or different. The device types include: at least one of a smartphone, a tablet computer, an E-book reader, an MP3 player, an MP4 player, a laptop computer, a desk computer, and the like.

Only two terminals are shown in FIG. 4, but in different aspects, there are a plurality of other terminals 140 that can access the server 120. In some aspects, there are also one or more terminals 140 that correspond to developers. A development and editing platform for a client that supports a virtual environment is installed on the terminal 140. A developer can edit and update the client on the terminal 140, and transmit an updated client installation package to the server 120 through a wired or wireless network. The first terminal 110 and the second terminal 130 can download the client installation package from the server 120 to update the client.

The first terminal 110, the second terminal 130, and the another terminal 140 are connected to the server 120 through a wireless or wired network.

The server 120 includes at least one of one server, multiple servers, a cloud computing platform, and a virtualization center. The server 120 is configured to provide a background service for a client that supports a three-dimensional virtual environment. In some aspects, the server 120 is responsible for primary computing work, and the terminal is responsible for secondary computing work. Alternatively, the server 120 is responsible for secondary computing work, and the terminal is responsible for primary computing work. Alternatively, a distributed computing architecture may be used between the server 120 and the terminal for collaborative computing.

In an example, the server 120 includes a processor 122, a user account database 123, a battle service module 124, and a user-oriented input/output interface (I/O interface) 125. The processor 122 is configured to load an instruction stored in the server 120 and process data in the user account database 123 and the battle service module 124. The user account database 123 is configured to store data of user accounts used by the first terminal 110, the second terminal 130, and the another terminal 140, such as avatars of the user accounts, nicknames of the user accounts, battle strength indexes of the user accounts, and service regions of the user accounts. The battle service module 124 is configured to provide a plurality of battle rooms for users to battle, for example, 1V1 battle, 3V3 battle, and 5V5 battle. The user-oriented I/O interface 125 is configured to establish communication and exchange data with the first terminal 110 and/or the second terminal 130 through a wireless network or a wired network.

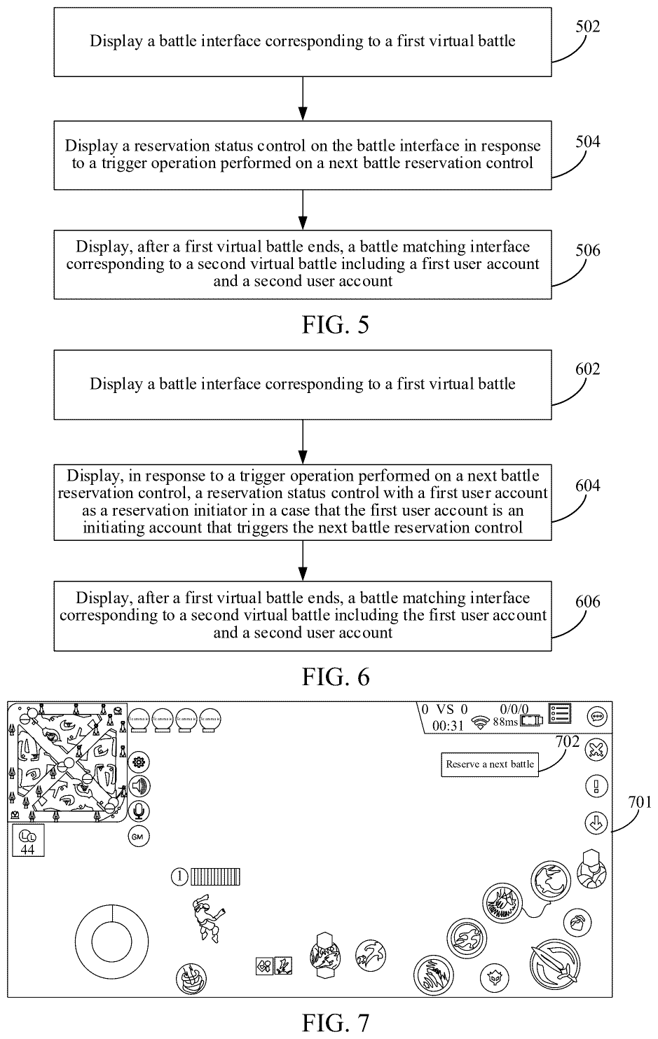

FIG. 5 is a flowchart of a virtual battle reservation method according to an aspect of this disclosure. The method may be performed by a first client, and a first user account is logged in on the first client. The method includes:

Operation 502: Display a battle interface corresponding to a first virtual battle. For example, a gaming interface corresponding to a first virtual game session that includes a plurality of users is displayed. The gaming interface includes a game reservation control element.

The battle interface displays a next battle reservation control.

The next battle reservation control is a control (for example, a button) for reserving a second virtual battle with a user account in the first virtual battle. The second virtual battle is behind the first virtual battle.

In some aspects, the user account in the first virtual battle is a user account that belongs to the same team in the first virtual battle, for example, a user account of a teammate. Alternatively, the user account in the first virtual battle is a user account that belongs to a different team in the first virtual battle, for example, a user account of an enemy virtual character.

For example, a next battle is reserved with a user account of a teammate of the same team by using the next battle reservation control, or a next battle is reserved with a user account of an enemy teammate by using the next battle reservation control.

In some aspects, a next battle is reserved with an entire team by using the next battle reservation control, or a next battle is reserved with an individual by using the next battle reservation control. This is not limited thereto. This is not specifically limited in this aspect of this disclosure.

Operation 504: Display a reservation status control on the battle interface in response to a trigger operation performed on a next battle reservation control. For example, based on a user selection of the game reservation control element in the gaming interface by a first user of the plurality of users, a reservation status control interface on the gaming interface is displayed. The reservation status control interface includes a reservation status indication identifier for each of a subset of the plurality of users. The reservation status indication identifier of each of the subset of the plurality of users indicates whether the respective user intends to participate in a second virtual game session.

The reservation status control includes at least one reservation status indication identifier.

In some aspects, for example, in 5V5 teaming, when a next battle is reserved with one user account in a specified manner by using the next battle reservation control, the reservation status control includes one reservation status indication identifier; and when a next battle is reserved with user accounts of one team by using the next battle reservation control, the reservation status control includes five reservation status indication identifiers; and when a next battle is reserved with all user accounts in the first virtual battle by using the next battle reservation control, the reservation status control includes ten reservation status indication identifiers.

A form of displaying the reservation status control includes: a form of a shape control or a form of an individual control corresponding to a user account, for example, a form of an avatar corresponding to the user account.

The reservation status indication identifier is used for indicating willingness representation of the user account to participate in the second virtual battle, or the reservation status indication identifier is used for indicating whether the user account is willing to participate in the second virtual battle. There is a one-to-one correspondence between the reservation status indication identifier and the user account.

For example, the first client displays the reservation status control on the battle interface in response to a trigger operation performed on the next battle reservation control, and the reservation status control is displayed in the second client corresponding to the user account receiving the reservation invitation in the first virtual battle.

In some aspects, a form of the reservation status indication identifier is at least one of an avatar of a virtual character corresponding to a user account, an identifier of a user account, a color box, and a shadow image, but is not limited thereto. This is not specifically limited in this aspect of this disclosure.

For example, by triggering the next battle reservation control on the battle interface corresponding to the first virtual battle, next battle reservation invitation is sent to another user account in the same team, and the reservation status control is displayed on a client corresponding to the another user account in the same team.

Operation 506: Display, after the first virtual battle ends, a battle matching interface corresponding to the second virtual battle including a first user account and a second user account. For example, after the first virtual game session has ended, a game matching interface corresponding to the second virtual game session is displayed. The game matching interface identifies each of the subset of the plurality of users of the first virtual game session that indicated intent to participate in the second virtual game session.

The second user account is a user account that is in the first virtual battle and that agrees to participate in the second virtual battle. The second user account is a user account that is in the first virtual battle and whose corresponding reservation status indication identifier indicates agreeing to participate in the second virtual battle.

In some aspects, the second user account is a user account that belongs to the same team or a user account that does not belong to the same team.

The battle matching interface is a team member matching interface corresponding to the second virtual battle, and the battle matching interface is used by the first user account and the second user account to participate in the second virtual battle. When team member matching succeeds, the second virtual battle can be started.

For example, after the first virtual battle ends, the first client skips a battle settlement interface of the first virtual battle and directly displays a battle matching interface of the second virtual battle. The second virtual battle can be directly started when team member matching succeeds, thereby avoiding a settlement waiting time and improving efficiency of starting a virtual battle.

In conclusion, according to the method provided in this aspect, a battle interface corresponding to a first virtual battle is displayed, a reservation status control is displayed on the battle interface in response to a trigger operation performed on a next battle reservation control, and a battle matching interface corresponding to the second virtual battle including a first user account and a second user account is displayed after the first virtual battle ends. In this disclosure, a next virtual battle is reserved with a user account in the current battle on the battle interface of the current battle, thereby avoiding a settlement process, reducing usage time of an entire virtual battle, and improving efficiency of starting a virtual battle.

FIG. 6 is a flowchart of a virtual battle reservation method according to an aspect of this disclosure. The method may be performed by a first client, and a first user account is logged in on the first client. The method includes:

Operation 602: Display a battle interface corresponding to a first virtual battle. For example, a gaming interface corresponding to a first virtual game session that includes a plurality of users is displayed. The gaming interface includes a game reservation control element.

The battle interface displays a next battle reservation control.

The next battle reservation control is a control (for example, a button) for reserving a second virtual battle with a user account in the first virtual battle.

In some aspects, a next battle is reserved with an entire team by using the next battle reservation control, or a next battle is reserved with an individual by using the next battle reservation control. This is not limited thereto. This is not specifically limited in this aspect of this disclosure.

FIG. 7 is a schematic diagram of a battle interface. A battle interface 701 includes a plain, a street, a valley, and the like for game characters to battle. For example, the battle interface 701 is displayed from a third-person perspective. The battle interface 701 displays a control virtual character and a next battle reservation control 702.

In some aspects, a display occasion of the next battle reservation control includes at least one of, but is not limited to, displaying at the beginning of the battle, displaying after a first time period of the beginning of the battle, always displaying in an entire battle process, or intermittently displaying in an entire battle process. This is not specifically limited in this aspect of this disclosure.

Operation 604: Display, in response to a trigger operation performed on the next battle reservation control, a reservation status control with the first user account as a reservation initiator in a case that the first user account is an initiating account that triggers the next battle reservation control. For example, the reservation status control interface with the first user designated as a reservation initiator is displayed based on the first user being first among the plurality of users to initiate a game session reservation function for the second virtual game session.

The reservation status control includes at least one reservation status indication identifier.

The reservation status indication identifier is used for indicating willingness representation of the user account to participate in the second virtual battle. There is a one-to-one correspondence between the reservation status indication identifier and the user account.

For example, the first client displays the reservation status control on the battle interface in response to a trigger operation performed on the next battle reservation control, and the reservation status control is displayed in the second client corresponding to the user account receiving the reservation invitation in the first virtual battle.

In some aspects, a form of the reservation status indication identifier is at least one of an avatar of a virtual character corresponding to a user account, an identifier of a user account, a color box, and a shadow image, but is not limited thereto. This is not specifically limited in this aspect of this disclosure.

In some aspects, a manner of triggering the next battle reservation control includes at least one of single click, double click, triple click, tap, and long press, but is not limited thereto. This is not specifically limited in this aspect of this disclosure.

For example, a reservation manner corresponding to the reservation status control includes:
reserving with a user account belonging to the same team;
reserving with a user account not belonging to the same team;
reserving with all user accounts in the same team through one click;
reserving, through one click, with all user accounts that participate in the current virtual battle;
reserving, through one click in a specified manner, with user accounts that participate in the current virtual battle; and
reserving automatically with n user accounts that are of user accounts that participate in the current virtual battle and that are ranked in the top n places, where n is a positive integer, and the rank may be a rank in the current virtual battle.

In an example, the first client displays, in the reservation status control with the first user account as the reservation initiator in response to the trigger operation performed on the next battle reservation control and in the case that the first user account is an initiating account that triggers the next battle reservation control in the same team, a reservation status indication identifier corresponding to a user account that is in the same team and that agrees to participate in the second virtual battle.

In some aspects, the first client sends a next battle reservation request to a server in response to the trigger operation performed on the next battle reservation control. The server is configured to synchronize the next battle reservation request to a client corresponding to another user account in the same team, and place the first user account into a reservation pool as the reservation initiator. The first client displays, in the reservation status control based on information about the user account in the reservation pool that is fed back by the server, the reservation status indication identifier corresponding to the user account that is in the same team and that agrees to participate in the second virtual battle.

The reservation pool is configured for temporarily storing a user account that is in the first virtual battle and that agrees to participate in the second virtual battle.

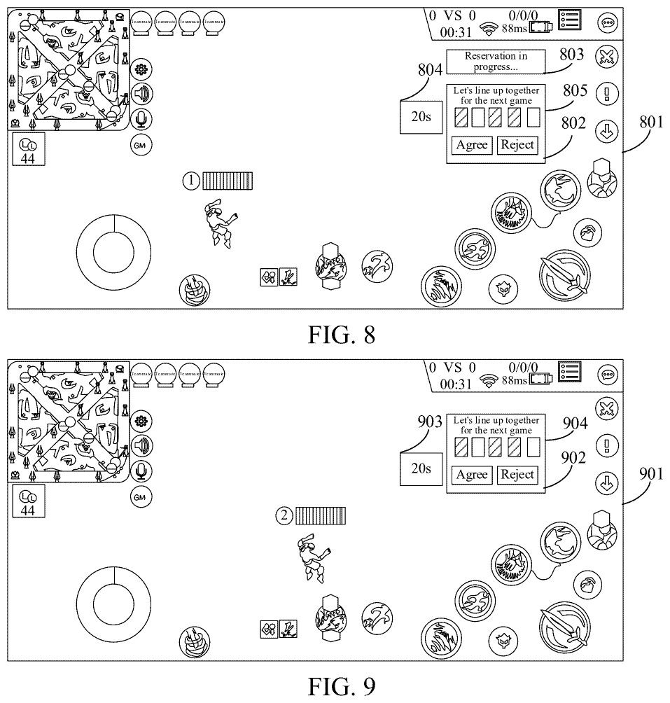

FIG. 8 is a schematic diagram of a battle interface of a first client. The first client displays a battle interface 801 corresponding to the first virtual battle. In response to a trigger operation performed on a next battle reservation control, the first client displays a reservation status control 802 on the battle interface 801. The reservation status control 802 includes at least one reservation status indication identifier 805, and the reservation status indication identifier 805 is used for indicating willingness representation of a user account to participate in the second virtual battle.

The first client switches the next battle reservation control to a reservation in-process control 803 in response to the trigger operation performed on the next battle reservation control. The reservation in-process control 803 is configured for ending or modifying the current reservation operation. The ending the current reservation operation is, for example, no longer reserving with any user account, and the modifying the current reservation operation is, for example, modifying a reservation manner corresponding to the reservation status control. In addition, a countdown identifier 804 is further displayed on the battle interface 801, and display of the reservation status control 802 with the first user account as the reservation initiator is canceled in a case that a display duration of the reservation status control 802 reaches a time threshold, that is, the countdown identifier 804 is reset to zero.

FIG. 9 is a schematic diagram of a battle interface of a second client. The second client displays a battle interface 901 corresponding to the first virtual battle. In response to a trigger operation performed on a next battle reservation control on the first client, the second client displays a reservation status control 902 on the battle interface 901. The reservation status control 902 includes at least one reservation status indication identifier 904, and the reservation status indication identifier 904 is used for indicating willingness representation of a user account to participate in the second virtual battle.

In addition, a countdown identifier 903 is further displayed on the battle interface 901, and display of the reservation status control 902 with the first user account as the reservation initiator is canceled in a case that a display duration of the reservation status control 902 reaches a time threshold, that is, the countdown identifier 903 is reset to zero.

The foregoing method uses an example in which a next battle is reserved with a user account in the same team. Similarly, the method may also be applied to reserve a next battle with a user account not belonging to the same team.

In an example, in response to the trigger operation performed on the next battle reservation control on the first client, in the case that the first user account is an initiating account in the same team that triggers the next battle reservation control, the reservation status control with the first user account as the reservation initiator is displayed on a client corresponding to another user account that does not belong to the same team as the first user account.

In some aspects, the first client sends a next battle reservation request to a server in response to the trigger operation performed on the next battle reservation control. The server is configured to synchronize the next battle reservation request to a client corresponding to another user account that does not belong to the same team as the first user account, and place the first user account into a reservation pool as the reservation initiator. The first client displays, in the reservation status control based on information about the user account in the reservation pool that is fed back by the server, the reservation status indication identifier corresponding to the user account that agrees to participate in the second virtual battle.

In an example, the first client displays, in the reservation status control in response to the trigger operation performed on the next battle reservation control and in a case that the first user account triggers the next battle reservation control in a specified manner, a reservation status indication identifier corresponding to a user account that is of user accounts invited for reservation in a specified manner and that agrees to participate in the second virtual battle.

In some aspects, the first client sends a specified next battle reservation request to the server in response to a specified trigger operation performed on the next battle reservation control. The server is configured to synchronize the specified next battle reservation request to a client corresponding to a user account invited for reservation in a specified manner in the first virtual battle, and place the first user account into a reservation pool as the reservation initiator.

The first client displays, in the reservation status control based on information about the user account in the reservation pool that is fed back by the server, the reservation status indication identifier corresponding to the user account that is of the user accounts invited for reservation in a specified manner and that agrees to participate in the second virtual battle.

In some aspects, the next battle reservation control further includes an individual next battle reservation control. There is a one-to-one correspondence between the individual next battle reservation control and the user account.

The first client sends a specified next battle reservation request to the server in response to a specified trigger operation performed on the individual next battle reservation control. The server receives the specified next battle reservation request, and sends the specified next battle reservation request to a client corresponding to the individual next battle reservation control. When the user account on the client corresponding to the individual next battle reservation control agrees to participate in the second virtual battle, the server places user account information of the user account into the reservation pool. When the user account on the client corresponding to the individual next battle reservation control does not agree to participate in the second virtual battle, the server does not place user account information of the user account into the reservation pool. The server sends the user account information in the reservation pool to the first client, and the first client displays a reservation status indication identifier corresponding to a user account that agrees to participate in the second virtual battle.

The specified next battle reservation request is configured for requesting a user account corresponding to the individual next battle reservation control to participate in the second virtual battle; and the server is configured to synchronize the specified next battle reservation request to the client corresponding to the user account invited for reservation in a specified manner in the first virtual battle.

In some aspects, a display form of the individual next battle reservation control is at least one of, but is not limited to, an avatar corresponding to an individual user account, a serial number corresponding to the individual user account, and character information corresponding to the individual user account. This is not specifically limited in this aspect of this disclosure.

The next battle reservation control is a control (for example, a button) for reserving the second virtual battle with a user account that belongs to the same team in the first virtual battle, or the next battle reservation control is a control (for example, a button) for reserving the second virtual battle with all user accounts in the first virtual battle. That is, the next battle reservation control is triggered on the first client to reserve a next battle with an entire team, with a user account that belongs to the same team, or with a user account that does not belong to the same team in the first virtual battle.

The individual next battle reservation control is a control (for example, a button) for reserving the second virtual battle with a single user account in the first virtual battle. Each user account in the first virtual battle corresponds to one individual next battle reservation control. Reservation with a user account may be implemented in a specified manner by triggering the individual next battle reservation control corresponding to the user account. That is, a next battle is reserved with an individual user account in the first virtual battle by triggering the individual next battle reservation control in the first client, to implement reservation in a specified manner.

In some aspects, a display form of the individual next battle reservation control is at least one of, but is not limited to, an avatar corresponding to an individual user account, a serial number corresponding to the individual user account, and character information corresponding to the individual user account. This is not specifically limited in this aspect of this disclosure.

For example, in a game battle, the first user account initiates the next battle reservation request to only some user accounts by triggering the next battle reservation control. For example, if the first user account initiates the next battle reservation request to a user account corresponding to an enemy virtual character, the reservation status control with the first user account as the reservation initiator is only displayed in a client corresponding to the user account of the enemy virtual character receiving the reservation invitation in the first virtual battle, that is, the reservation status control is not displayed in a client corresponding to another user account not receiving the reservation invitation.

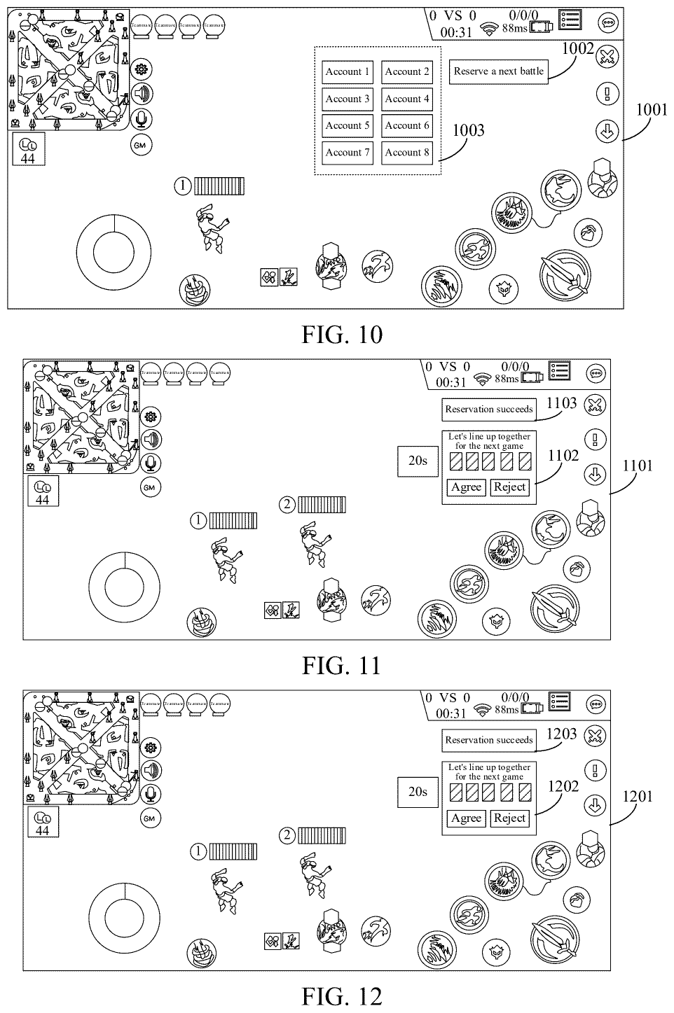

For example, FIG. 10 is a schematic diagram of an individual next battle reservation control. The first client displays a battle interface 1001 corresponding to the first virtual battle. In response to a trigger operation performed on a next battle reservation control 1002, the first client displays an individual next battle reservation control 1003 on the battle interface 1001. There is a one-to-one correspondence between the individual next battle reservation control 1003 and the user account in the first virtual battle.

In some aspects, the individual next battle reservation control 1003 is always displayed on the battle interface 1001, or is displayed only by triggering the next battle reservation control 1002, but is not limited thereto. A display manner of the individual next battle reservation control 1003 is not specifically limited in this aspect of this disclosure. For example, FIG. 10 displays individual next battle reservation controls 1003 corresponding to eight user accounts. By triggering the next battle reservation control 1002, a next battle reservation request may be initiated to the eight user accounts, or a next battle reservation request may be initiated to a user account belonging to the same team. By triggering the individual next battle reservation control 1003, a next battle reservation request may be initiated to a single user account corresponding to the individual next battle reservation control 1003.

In an example, the first client dynamically displays, in the reservation status control in response to the trigger operation performed on the next battle reservation control, the reservation status indication identifier corresponding to the user account that agrees to participate in the second virtual battle.

In some aspects, the dynamically displaying a reservation status indication identifier includes: at least one of highlighting a reservation status indication identifier of a corresponding user account, flashing a reservation status indication identifier of a corresponding user account, and displaying an avatar of a corresponding user account on a reservation status indication identifier of the user account, but is not limited thereto. This is not specifically limited in this aspect of this disclosure.

In an example, display of the reservation status control with the first user account as the reservation initiator is canceled in a case that the reservation status control satisfies a display cancellation condition.

In some aspects, the display cancellation condition corresponding to the reservation status control includes:
all user accounts receiving next battle reservation invitation agree to participate in the second virtual battle;
at least one user account does not agree to participate in the second virtual battle, and the display duration of the reservation status control reaches the time threshold; and
none of user accounts receiving next battle reservation invitation agrees to participate in the second virtual battle.

In some aspects, display of the reservation status control with the first user account as the reservation initiator is canceled in a case that all user accounts receiving next battle reservation invitation agree to participate in the second virtual battle.

In some aspects, a countdown identifier is displayed on the battle interface, and display of the reservation status control with the first user account as the reservation initiator is canceled in a case that at least one user account receiving next battle reservation invitation does not agree to participate in the second virtual battle and a display duration of the reservation status control reaches a time threshold, that is, the countdown identifier is reset to zero.

For example, when the next battle reservation control is triggered, the battle interface displays the reservation status control with the first user account as the reservation initiator, and a display time of the reservation status control is 20 s. When all user accounts in the same team agree to participate in the second virtual battle, display of the reservation status control with the first user account as the reservation initiator is canceled. For example, when the countdown identifier is 10 s, all user accounts in the same team agree to participate in the second virtual battle, and display of the reservation status control and the countdown identifier is directly canceled. Alternatively, display of the reservation status control with the first user account as the reservation initiator is canceled in a case that at least one user account in the same team does not agree to participate in the second virtual battle and the countdown identifier is reset to 0.

In a possible implementation, a reservation in-process control is further displayed on the battle interface; and the first client switches the next battle reservation control to the reservation in-process control on the battle interface in response to the trigger operation performed on the next battle reservation control.

The reservation in-process control is configured for ending or modifying the current reservation operation.

Operation 606: Display, after the first virtual battle ends, a battle matching interface corresponding to the second virtual battle including a first user account and a second user account. For example, after the first virtual game session has ended, a game matching interface corresponding to the second virtual game session is displayed. The game matching interface identifies each of the subset of the plurality of users of the first virtual game session that indicated intent to participate in the second virtual game session.

The second user account is a user account that is in the first virtual battle and that agrees to participate in the second virtual battle. The second user account is a user account that is in the first virtual battle and whose corresponding reservation status indication identifier indicates agreeing to participate in the second virtual battle.

In some aspects, the second user account is a user account that belongs to the same team or a user account that does not belong to the same team.

The battle matching interface is a team member matching interface corresponding to the second virtual battle, and the battle matching interface is used by the first user account and the second user account to participate in the second virtual battle. When team member matching succeeds, the second virtual battle can be started.

For example, after the first virtual battle ends, the first client skips a battle settlement interface of the first virtual battle and directly displays a battle matching interface of the second virtual battle. The second virtual battle can be directly started when team member matching succeeds, thereby avoiding a settlement waiting time and improving efficiency of starting a virtual battle.

For example, the first client displays, after the first virtual battle ends in a case that the reservation operation for the second virtual battle succeeds, the battle matching interface corresponding to the second virtual battle including the first user account and the second user account.

In some aspects, the first client displays, after the first virtual battle ends and in a case that a quantity of user accounts that are in the same team and that agree to participate in the second virtual battle is greater than a quantity threshold, the battle matching interface corresponding to the second virtual battle including the first user account and the second user account.

FIG. 11 is a schematic diagram of a battle interface on which next battle reservation succeeds. The first client displays a battle interface 1101 corresponding to the first virtual battle. In response to a trigger operation performed on a next battle reservation control, the first client displays a reservation status control 1102 on the battle interface 1101. The first client switches the next battle reservation control to a reservation in-process control in response to the trigger operation performed on the next battle reservation control. In a case that a quantity of user accounts that are in the same team and that agree to participate in the second virtual battle is greater than a quantity threshold, the reservation in-process control is switched to a reservation success control 1103.

For example, when the same team includes five user accounts, and a quantity of user accounts that are of the five user accounts and that agree to participate in the second virtual battle is greater than three, the reservation operation for the second virtual battle succeeds. The battle matching interface corresponding to the second virtual battle displays the first user account as the reservation initiator and the second user account that agrees to participate in the second virtual battle, and the first client starts the second virtual battle in response to a trigger operation performed on a start matching control.

In some aspects, the first client displays, after the first virtual battle ends and in a case that all user accounts in the same team agree to participate in the second virtual battle, the battle matching interface corresponding to the second virtual battle including the first user account and the second user account.

FIG. 12 is a schematic diagram of a battle interface on which next battle reservation succeeds. The first client displays a battle interface 1201 corresponding to the first virtual battle. In response to a trigger operation performed on a next battle reservation control, the first client displays a reservation status control 1202 on the battle interface 1201. The first client switches the next battle reservation control to a reservation in-process control in response to the trigger operation performed on the next battle reservation control. In a case that all user accounts in the same team agree to participate in the second virtual battle, the reservation in-process control is switched to a reservation success control 1203.

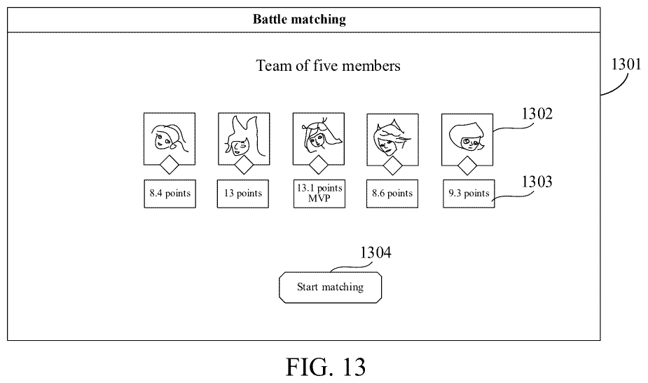

FIG. 13 is a schematic diagram of a battle matching interface after next battle reservation succeeds. The first client displays, after the first virtual battle ends and in a case that the reservation operation for the second virtual battle succeeds, a battle matching interface 1301 corresponding to the second virtual battle including the first user account and the second user account. When the first user account and the second user account in the battle matching interface 1301 are all user accounts in the first virtual battle, avatar identifiers 1302 corresponding to all the user accounts in the first virtual battle and performance scores 1303 of all the user accounts in the first virtual battle are displayed in the battle matching interface 1301. The first client directly starts the second virtual battle in response to a trigger operation performed on a start matching control 1304.

In some aspects, when all user accounts in the same team agree to participate in the second virtual battle, the first client directly starts the second virtual battle in response to the trigger operation performed on the start matching control.

In some aspects, for example, the same team includes five persons. When not all the user accounts in the same team agree to participate in the second virtual battle, in response to the trigger operation performed on the start matching control, the first client establishes a team based on the first user account and the second user account that agrees to participate in the second virtual battle, and starts the second virtual battle after a small team of five persons is established.

For example, the first client displays a battle settlement interface of the first virtual battle after the first virtual battle ends and in a case that the reservation operation for the second virtual battle fails.

In a possible implementation, a history virtual battle record of the first user account is obtained; an interaction record between the second user account and the first user account is extracted from the history virtual battle record, and the interaction record is evaluated by using an interaction record evaluation model, to obtain an interaction score corresponding to the interaction record; and when the interaction score is greater than a score threshold, the second user account agrees to participate in the second virtual battle by default.

In some aspects, a ratio of a teaming time of the second user account to a teaming time of the first user account is extracted from the history virtual battle record; and the teaming time ratio is evaluated by using the interaction record evaluation model, to obtain an interaction score corresponding to the teaming time ratio.

The teaming time ratio is a ratio of a time length in which the second user account and the first user account belong to the same team to a time length of the history virtual battle record.

In some aspects, a ratio of a chat time length of the second user account to a chat time length of the first user account is extracted from the history virtual battle record; and the chat time length ratio is evaluated by using the interaction record evaluation model, to obtain an interaction score corresponding to the chat time length ratio.

The chat time length ratio is a ratio of a chat time length of the second user account and the first user account to a time length of the history virtual battle record.

In a possible implementation, when the second user account and a third user account are friends, and the third user account agrees to participate in the second virtual battle, the second user account agrees to participate in the second virtual battle together with the third user account.

For example, the reservation status control includes at least one reservation status indication identifier, and there is a one-to-one correspondence between the reservation status indication identifier and the user account. A following control corresponding to the user account is additionally displayed by triggering the reservation status indication identifier. In response to a trigger operation performed on the following control, when a followed user account agrees to participate in the second virtual battle, a following user account agrees to participate in the second virtual battle by default.

The following control is used for controlling the following user account to follow the followed user account to make the same response to next battle reservation.

In a possible implementation, in a case that a quantity of user accounts that are of user accounts receiving next battle reservation invitation and that agree to participate in the second virtual battle is greater than a quantity threshold, the second user account agrees to participate in the second virtual battle by default.

For example, the reservation status control includes at least one reservation status indication identifier, and there is a one-to-one correspondence between the reservation status indication identifier and the user account. A majority following control is additionally displayed by triggering the reservation status indication identifier corresponding to an individual user account (that is, the first user account). In response to a trigger operation performed on the majority following control, when a quantity of user accounts that agree to participate in the second virtual battle exceeds a quantity threshold, the user account agrees to participate in the second virtual battle by default.

In a possible implementation, when the second user account and the first user account are friends, the second user account agrees to participate in the second virtual battle by default.

When the second user account agrees to participate in the previous first virtual battle, the second user account agrees to participate in the second virtual battle by default.

In conclusion, according to the method provided in this aspect, a battle interface corresponding to a first virtual battle is displayed, a reservation status control is displayed on the battle interface in response to a trigger operation performed on a next battle reservation control, and a battle matching interface corresponding to the second virtual battle including a first user account and a second user account is displayed after the first virtual battle ends. In this disclosure, a next virtual battle is reserved with a user account in the current battle on the battle interface of the current battle, thereby avoiding a settlement process, reducing usage time of an entire virtual battle, and improving efficiency of starting a virtual battle.

According to the method provided in this aspect, in response to a trigger operation performed on a next battle reservation control, in a case that the first user account is an initiating account that triggers the next battle reservation control, the reservation status control is displayed with the first user account as the reservation initiator. The first user account not only can make a reservation with another user account in the same team, but also can make a reservation with a user account in the first virtual battle in a specified manner. This disclosure provides multiple reservation manners. The first user account may implement next battle reservation in different reservation manners, thereby improving user experience. In addition, in a next battle reservation process, an initiator of the current reservation and a response of a user account in the first virtual battle to the current next battle reservation can be seen on the first client, that is, several user accounts that agree to the current next battle reservation can be seen in real time. According to the method provided in this aspect, display of the reservation status control with the first user account as the reservation initiator is canceled in a case that the reservation status control satisfies a display cancellation condition. By canceling display of the reservation status control, this avoids that the reservation status control blocks the battle interface, so that a display area of a virtual environment image is increased and a user has a broader field of view, thereby improving user experience. According to the method provided in this aspect, in response to a trigger operation performed on the next battle reservation control, the next battle reservation control is switched to a reservation in-process control on the battle interface. By canceling one control and displaying one control, this avoids that the control blocks the battle interface, so that a display area of a virtual environment image is increased and a user has a broader field of view, thereby improving user experience.

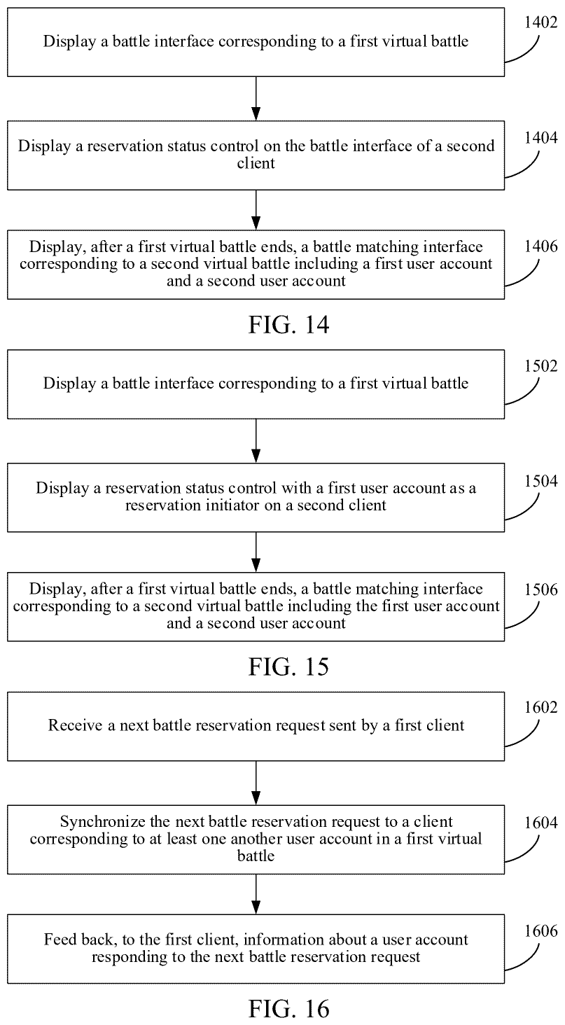

FIG. 14 is a flowchart of a virtual battle reservation method according to an aspect of this disclosure. The method may be performed by a second client. The method includes:

Operation 1402: Display a battle interface corresponding to a first virtual battle.

The battle interface displays a next battle reservation control.

The next battle reservation control is a control (for example, a button) for reserving a second virtual battle with a user account in the first virtual battle.

In some aspects, the user account in the first virtual battle is a user account that belongs to the same team in the first virtual battle, for example, a user account of a teammate. Alternatively, the user account in the first virtual battle is a user account that belongs to a different team in the first virtual battle, for example, a user account of an enemy virtual character.

For example, a next battle is reserved with a user account of a teammate of the same team by using the next battle reservation control, or a next battle is reserved with a user account of an enemy teammate by using the next battle reservation control.

In some aspects, a next battle is reserved with an entire team by using the next battle reservation control, or a next battle is reserved with an individual by using the next battle reservation control. This is not limited thereto. This is not specifically limited in this aspect of this disclosure.

Operation 1404: Display a reservation status control on the battle interface of the second client.

For example, the reservation status control is displayed when the next battle reservation control on the first client is triggered.

The reservation status control includes at least one reservation status indication identifier.

In some aspects, for example, in 5V5 teaming, when a next battle is reserved with one user account in a specified manner by using the next battle reservation control, the reservation status control includes one reservation status indication identifier; and when a next battle is reserved with user accounts of one team by using the next battle reservation control, the reservation status control includes five reservation status indication identifiers; and when a next battle is reserved with all user accounts in the first virtual battle by using the next battle reservation control, the reservation status control includes ten reservation status indication identifiers.

The reservation status indication identifier is used for indicating willingness representation of the user account to participate in the second virtual battle, or the reservation status indication identifier is used for indicating whether the user account is willing to participate in the second virtual battle. There is a one-to-one correspondence between the reservation status indication identifier and the user account.

The second virtual battle is behind the first virtual battle.

A form of displaying the reservation status control includes: a form of a shape control or a form of an individual control corresponding to a user account, for example, a form of an avatar corresponding to the user account.

For example, the reservation status control is displayed on the battle interface of the second client in a case that a next battle reservation control on the first client is triggered and the first client sends a next battle reservation request to the second client.

In some aspects, a form of the reservation status indication identifier is at least one of an avatar of a virtual character corresponding to a user account, an identifier of a user account, a color box, and a shadow image, but is not limited thereto. This is not specifically limited in this aspect of this disclosure.

Operation 1406: Display, after the first virtual battle ends, a battle matching interface corresponding to the second virtual battle including a first user account and a second user account.

The second user account is a user account that is in the first virtual battle and that agrees to participate in the second virtual battle. The second user account is a user account that is in the first virtual battle and whose corresponding reservation status indication identifier indicates agreeing to participate in the second virtual battle.

In some aspects, the second user account is a user account that belongs to the same team or a user account that does not belong to the same team.

The battle matching interface is a team member matching interface corresponding to the second virtual battle, and the battle matching interface is used by the first user account and the second user account to participate in the second virtual battle. When team member matching succeeds, the second virtual battle can be started.

For example, after the first virtual battle ends, the second client skips a battle settlement interface of the first virtual battle and directly displays a battle matching interface of the second virtual battle. The second virtual battle can be directly started when team member matching succeeds, thereby avoiding a settlement waiting time and improving efficiency of starting a virtual battle.

In conclusion, according to the method provided in this aspect, a battle interface corresponding to a first virtual battle is displayed, a reservation status control is displayed on the battle interface of a second client in a case that a next battle reservation control on the first client is triggered; and a battle matching interface corresponding to the second virtual battle including a first user account and a second user account is displayed after the first virtual battle ends. In this disclosure, a next virtual battle is reserved with a user account in the current battle on the battle interface of the current battle, thereby avoiding a settlement process, reducing usage time of an entire virtual battle, and improving efficiency of starting a virtual battle.

FIG. 15 is a flowchart of a virtual battle reservation method according to an aspect of this disclosure. The method may be performed by a second client. The method includes:

Operation 1502: Display a battle interface corresponding to a first virtual battle.

The battle interface displays a next battle reservation control. The next battle reservation control is a control (for example, a button) for reserving a second virtual battle with a user account in the first virtual battle. The second virtual battle is behind the first virtual battle.

In some aspects, a next battle is reserved with an entire team by using the next battle reservation control, or a next battle is reserved with an individual by using the next battle reservation control. This is not limited thereto. This is not specifically limited in this aspect of this disclosure.

In some aspects, a display occasion of the next battle reservation control includes at least one of, but is not limited to, displaying at the beginning of the battle, displaying after a first time period of the beginning of the battle, always displaying in an entire battle process, or intermittently displaying in an entire battle process. This is not specifically limited in this aspect of this disclosure.

Operation 1504: Display the reservation status control with the first user account as a reservation initiator on the second client.

For example, the reservation status control is displayed when the next battle reservation control on the first client is triggered. The reservation status control includes at least one reservation status indication identifier. The reservation status indication identifier is used for indicating willingness representation of the user account to participate in the second virtual battle, or the reservation status indication identifier is used for indicating whether the user account is willing to participate in the second virtual battle. There is a one-to-one correspondence between the reservation status indication identifier and the user account.

For example, when the next battle reservation control is triggered on the first client and the first client sends next battle reservation invitation to the second client, the reservation status control is displayed on the battle interface of the second client.

In some aspects, a form of the reservation status indication identifier is at least one of an avatar of a virtual character corresponding to a user account, an identifier of a user account, a color box, and a shadow image, but is not limited thereto. This is not specifically limited in this aspect of this disclosure.

For example, the first user account is logged in on the first client, and the first user account as the reservation initiator is determined when the first user account is an initiating account that triggers the next battle reservation control. That is, when the first user account is an initiating account that triggers the next battle reservation control, the reservation status control with the first user account as a reservation initiator is displayed on the second client.

For example, the reservation status indication identifier corresponding to the user account that is in the same team and that agrees to participate in the second virtual battle is displayed in the reservation status control on the second client.

In some aspects, the second client receives a next battle reservation request synchronized by a server. The second client sends a first response instruction of the next battle reservation request to the server in response to a trigger operation on the second client that responds to the next battle reservation request. The first response instruction is used for indicating response representation of whether the user account in the same team participates in the second virtual battle. The first response instruction is used by the server to place the user account that is in the same team and that agrees to participate in the second virtual battle into the reservation pool. The second client displays, in the reservation status control on the second client based on information about the user account in the reservation pool that is fed back by the server, the reservation status indication identifier corresponding to the user account that is in the same team and that agrees to participate in the second virtual battle.

The next battle reservation request is generated after the next battle reservation control on the first client is triggered.

The server is configured to synchronize the next battle reservation request on the first client to a client corresponding to another user account in the same team, and place the first user account into a reservation pool as the reservation initiator. The reservation pool is configured for temporarily storing a user account that is in the first virtual battle and that agrees to participate in the second virtual battle.

For example, a reservation status indication identifier corresponding to a user account that is of user accounts invited for reservation in a specified manner and that agrees to participate in the second virtual battle is displayed in the reservation status control on the second client.

Inviting in reservation in a specified manner is an operation of inviting a specified user account to a next battle on the first client.

In some aspects, the next battle reservation control further includes an individual next battle reservation control. There is a one-to-one correspondence between the individual next battle reservation control and the user account. The second client receives a specified next battle reservation request synchronized by a server. The second client sends a second response instruction of the specified next battle reservation request to the server in response to a trigger operation on the second client that responds to the specified next battle reservation request. The second response instruction is used for indicating response representation of whether the user account invited for reservation in a specified manner participates in the second virtual battle. The second response instruction is used by the server to place the user account that is of the user accounts invited for reservation in a specified manner and that agrees to participate in the second virtual battle into the reservation pool. The second client displays, in the reservation status control on the second client based on information about the user account in the reservation pool that is fed back by the server, the reservation status indication identifier corresponding to the user account that is of the user accounts invited for reservation in a specified manner and that agrees to participate in the second virtual battle.

The specified next battle reservation request is generated after the individual next battle reservation control on the first client is triggered.

The server is configured to synchronize the specified next battle reservation request on the first client to a client corresponding to a user account invited for reservation in a specified manner in the first virtual battle, and place the first user account into the reservation pool as the reservation initiator.

The next battle reservation control is a control (for example, a button) for reserving the second virtual battle with a user account that belongs to the same team in the first virtual battle, or the next battle reservation control is a control (for example, a button) for reserving the second virtual battle with all user accounts in the first virtual battle.

The individual next battle reservation control is a control (for example, a button) for reserving the second virtual battle with a single user account in the first virtual battle. Each user account in the first virtual battle corresponds to one individual next battle reservation control. Reservation with a user account may be implemented in a specified manner by triggering the individual next battle reservation control corresponding to the user account.

In an example, the reservation status indication identifier corresponding to the user account that agrees to participate in the second virtual battle is dynamically displayed in the reservation status control. In some aspects, the dynamically displaying a reservation status indication identifier includes: at least one of highlighting a reservation status indication identifier of a corresponding user account, flashing a reservation status indication identifier of a corresponding user account, and displaying an avatar of a corresponding user account on a reservation status indication identifier of the user account, but is not limited thereto. This is not specifically limited in this aspect of this disclosure.

In an example, display of the reservation status control with the first user account as the reservation initiator is canceled on the second client in a case that the reservation status control satisfies a display cancellation condition.

In some aspects, the display cancellation condition corresponding to the reservation status control includes:
all user accounts receiving next battle reservation invitation agree to participate in the second virtual battle;
at least one user account does not agree to participate in the second virtual battle, and the display duration of the reservation status control reaches the time threshold; and
none of user accounts receiving next battle reservation invitation agrees to participate in the second virtual battle.

In some aspects, display of the reservation status control with the first user account as the reservation initiator is canceled on the second client in a case that all user accounts receiving next battle reservation invitation agree to participate in the second virtual battle.

In some aspects, a countdown identifier is displayed on the battle interface, and display of the reservation status control with the first user account as the reservation initiator is canceled on the second client in a case that at least one user account receiving next battle reservation invitation does not agree to participate in the second virtual battle and a display duration of the reservation status control reaches a time threshold, that is, the countdown identifier is reset to zero.

For example, when the next battle reservation control is triggered on the first client, the battle interface of the second client displays the reservation status control with the first user account as the reservation initiator, and a display time of the reservation status control is 20 s. When all user accounts in the same team agree to participate in the second virtual battle, display of the reservation status control with the first user account as the reservation initiator is canceled. For example, when the countdown identifier is 10 s, all user accounts in the same team agree to participate in the second virtual battle, and display of the reservation status control and the countdown identifier is directly canceled. Alternatively, display of the reservation status control with the first user account as the reservation initiator is canceled in a case that at least one user account in the same team does not agree to participate in the second virtual battle and the countdown identifier is reset to 0.

Operation 1506: Display, after the first virtual battle ends, a battle matching interface corresponding to the second virtual battle including a first user account and a second user account.

The second user account is a user account that is in the first virtual battle and that agrees to participate in the second virtual battle. The second user account is a user account that is in the first virtual battle and whose corresponding reservation status indication identifier indicates agreeing to participate in the second virtual battle.

In some aspects, the second user account is a user account that belongs to the same team or a user account that does not belong to the same team.

The battle matching interface is a team member matching interface corresponding to the second virtual battle, and the battle matching interface is used by the first user account and the second user account to participate in the second virtual battle. When team member matching succeeds, the second virtual battle can be started.

For example, the second client directly displays, after the first virtual battle ends and in a case that the reservation operation for the second virtual battle succeeds, the battle matching interface corresponding to the second virtual battle including the first user account and the second user account, thereby avoiding a settlement waiting time and improving efficiency of starting a virtual battle.

In some aspects, the second client directly displays, after the first virtual battle ends and in a case that a quantity of user accounts that are in the agree to participate in the second virtual battle is greater than a quantity threshold, the battle matching interface corresponding to the second virtual battle including the first user account and the second user account.

For example, when the same team includes five user accounts, and a quantity of user accounts that are of the five user accounts and that agree to participate in the second virtual battle is greater than three, the reservation operation for the second virtual battle succeeds. The battle matching interface corresponding to the second virtual battle displays the first user account as the reservation initiator and the second user account that agrees to participate in the second virtual battle.

In some aspects, the second client displays, after the first virtual battle ends and in a case that all user accounts in the same team agree to participate in the second virtual battle, the battle matching interface corresponding to the second virtual battle including the first user account and the second user account.

For example, the second client displays a battle settlement interface of the first virtual battle after the first virtual battle of the second client ends and in a case that the reservation operation for the second virtual battle fails.

In conclusion, according to the method provided in this aspect, a battle interface corresponding to a first virtual battle is displayed, a reservation status control is displayed on the battle interface of a second client in a case that a next battle reservation control on the first client is triggered; and a battle matching interface corresponding to the second virtual battle including a first user account and a second user account is displayed after the first virtual battle ends. In this disclosure, a next virtual battle is reserved with a user account in the current battle on the battle interface of the current battle, thereby avoiding a settlement process, reducing usage time of an entire virtual battle, and improving efficiency of starting a virtual battle. In addition, in a process of reserving a next battle, an initiator of this reservation and a response of a user account in the first virtual battle to this next battle reservation can be seen on the second client.

FIG. 16 is a flowchart of a virtual battle reservation method according to an aspect of this disclosure. The method may be performed by a server. The method includes:

Operation 1602: Receive a next battle reservation request sent by a first client.

The next battle reservation request is used for inviting a user account in a first virtual battle to participate in a second virtual battle. The second virtual battle is behind the first virtual battle.

In some aspects, the next battle reservation request is obtained when a user account in the first virtual battle triggers a next battle reservation control on a corresponding client.

In some aspects, the next battle reservation request is at least one of, but is not limited to, reserving a next battle with a user account in the first virtual battle, reserving a next battle with a user account that belongs to the same team in the first virtual battle, and reserving a next battle with a user account that does not belong to the same team in the first virtual battle. This is not specifically limited in this aspect of this disclosure.

Operation 1604: Synchronize the next battle reservation request to a client corresponding to at least one another user account in the first virtual battle.

For example, when the first user account triggers the next battle reservation control in the first client, the first client generates a next battle reservation request and sends the next battle reservation request to the server. When the server receives the next battle reservation request, the server synchronizes the next battle reservation request to the client corresponding to the at least one another user account in the first virtual battle.

The another user account in the first virtual battle is a user account that belongs to the same team in the first virtual battle, for example, a user account of a teammate. Alternatively, the another user account in the first virtual battle is a user account that belongs to a different team in the first virtual battle, for example, a user account of an enemy virtual character. Alternatively, the another user account in the first virtual battle is all user accounts in the first virtual battle other than the first user account. Alternatively, the another user account in the first virtual battle is a user account reserved in a specified manner in the first virtual battle.

For example, the server receives the next battle reservation request sent by the first client, and the server synchronizes the next battle reservation request to a client corresponding to a user account of a teammate belonging to the same team in the first virtual battle, or the server synchronizes the next battle reservation request to a client corresponding to a user account of an enemy teammate in the first virtual battle.

Operation 1606: The server feeds back, to the first client, information about a user account responding to the next battle reservation request.

For example, after the server synchronizes the next battle reservation request to the client corresponding to the another user account in the first virtual battle, the client corresponding to the another user account responds to the next battle reservation request, that is, agrees to participate in the second virtual battle or does not agree to participate in the second virtual battle. After receiving the response made by the client corresponding to the another user account, the server feeds back, to the first client, user account information corresponding to the user account that makes the response.

In some aspects, the user account information is at least one of, but is not limited to, an avatar corresponding to the user account, an agreement identifier corresponding to the user account, and a non-agreement identifier corresponding to the user account. This is not specifically limited in this aspect of this disclosure.

In conclusion, according to the method provided in this aspect, the server receives the next battle reservation request sent by the first client, synchronizes the next battle reservation request to a client corresponding to another user account in the first virtual battle, and feeds back, to the first client, information about a user account responding to the next battle reservation request. After the first virtual battle ends, the server sends, to the first client, information about the battle matching interface corresponding to the second virtual battle including the first user account and the second user account. In this disclosure, a next virtual battle is reserved with a user account in the current battle on the battle interface of the current battle, thereby avoiding a settlement process, reducing usage time of an entire virtual battle, and improving efficiency of starting a virtual battle.

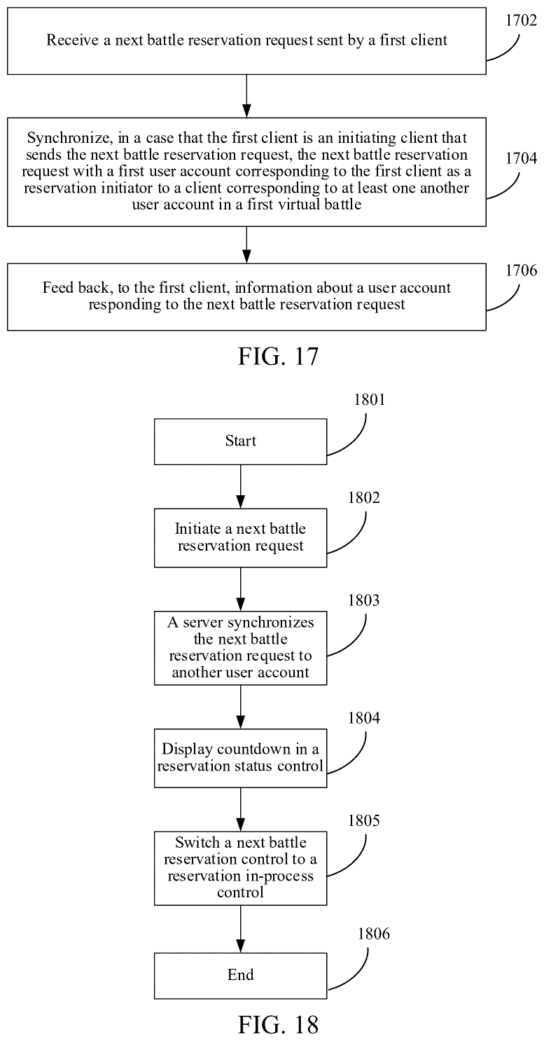

FIG. 17 is a flowchart of a virtual battle reservation method according to an aspect of this disclosure. The method may be performed by a server. The method includes: Operation 1702: Receive a next battle reservation request sent by a first client.

The next battle reservation request is used for inviting a user account in a first virtual battle to participate in a second virtual battle. The second virtual battle is behind the first virtual battle.

In some aspects, the next battle reservation request is obtained when a user account in the first virtual battle triggers a next battle reservation control on a corresponding client.

In some aspects, the next battle reservation request is at least one of, but is not limited to, reserving a next battle with a user account in the first virtual battle, reserving a next battle with a user account that belongs to the same team in the first virtual battle, and reserving a next battle with a user account that does not belong to the same team in the first virtual battle. This is not specifically limited in this aspect of this disclosure.

The at least one another user account in the first virtual battle is a user account that belongs to the same team in the first virtual battle, for example, a user account of a teammate. Alternatively, the at least one another user account in the first virtual battle is a user account that belongs to a different team in the first virtual battle, for example, a user account of an enemy virtual character.

Operation 1704: The server synchronizes, in a case that the first client is an initiating client that transmits the next battle reservation request, the next battle reservation request with the first user account corresponding to the first client as a reservation initiator to the client corresponding to the at least one another user account in the first virtual battle.

For example, the server receives the next battle reservation request sent by the first client, and synchronizes, in a case that the first client is an initiating client that transmits the next battle reservation request, the next battle reservation request with the first user account corresponding to the first client as a reservation initiator to the client corresponding to the at least one another user account in the first virtual battle.

In some aspects, the server receives the next battle reservation request sent by the first client, synchronizes, in a case that the first client is an initiating client that transmits the next battle reservation request in the same team, the next battle reservation request to a client corresponding to another user account in the same team, and places the first user account into a reservation pool as the reservation initiator.

The reservation pool is configured for temporarily storing a user account that is in the first virtual battle and that agrees to participate in the second virtual battle.

For example, the server receives the specified next battle reservation request sent by the first client, synchronizes the specified next battle reservation request to a client corresponding to a user account invited for reservation in a specified manner, and places the first user account into a reservation pool as the reservation initiator.

Operation 1706: The server feeds back, to the first client, information about a user account responding to the next battle reservation request.

After the server synchronizes the next battle reservation request to the client corresponding to the at least one another user account in the first virtual battle, the client corresponding to the another user account responds to the next battle reservation request, that is, agrees to participate in the second virtual battle or does not agree to participate in the second virtual battle. After receiving the response made by the client corresponding to the another user account, the server feeds back, to the first client, user account information corresponding to the user account that makes the response. The user account information fed back the server is displayed in a reservation status control on the first client.

The reservation status control includes at least one reservation status indication identifier.

The reservation status indication identifier is used for indicating willingness representation of the user account to participate in the second virtual battle. There is a one-to-one correspondence between the reservation status indication identifier and the user account.

In some aspects, a form of the reservation status indication identifier is at least one of an avatar of a virtual character corresponding to a user account, an identifier of a user account, a color box, and a shadow image, but is not limited thereto. This is not specifically limited in this aspect of this disclosure.

In some aspects, the user account information is at least one of, but is not limited to, an avatar corresponding to the user account, an agreement identifier corresponding to the user account, and a non-agreement identifier corresponding to the user account. This is not specifically limited in this aspect of this disclosure.

For example, when the first client is an initiating client in the same team that sends the next battle reservation request, the server sends, to the first client, user account information corresponding to a user account that is in the same team in the reservation pool and that agrees to participate in the second virtual battle.

For example, when the first client sends a specified next battle reservation request to a user account in the first virtual battle, the server sends, to the first client, user account information corresponding to a user account that is of user accounts invited for reservation in a specified manner and that is in the reservation pool and agrees to participate in the second virtual battle.

For example, the server sends, to the first client in a case that the reservation status control on the first client satisfies a display cancellation condition, an instruction of canceling display of the reservation status control.

In some aspects, the server sends, to the first client in a case that all user accounts receiving next battle reservation invitation agree to participate in the second virtual battle, the instruction of canceling display of the reservation status control.

In some aspects, the server sends, to the first client in a case that at least one user account receiving next battle reservation invitation does not agree to participate in the second virtual battle and a display duration of the reservation status control reaches a time threshold, the instruction of canceling display of the reservation status control.

In a possible implementation, a history virtual battle record of the first user account is obtained; an interaction record between the second user account and the first user account is extracted from the history virtual battle record, and the interaction record is evaluated by using an interaction record evaluation model, to obtain an interaction score corresponding to the interaction record; and when the interaction score is greater than a score threshold, the second user account is placed into the reservation pool by default.

In some aspects, a ratio of a teaming time of the second user account to a teaming time of the first user account is extracted from the history virtual battle record; and the teaming time ratio is evaluated by using the interaction record evaluation model, to obtain an interaction score corresponding to the teaming time ratio.

The teaming time ratio is a ratio of a time length in which the second user account and the first user account belong to the same team to a time length of the history virtual battle record.

In some aspects, a ratio of a chat time length of the second user account to a chat time length of the first user account is extracted from the history virtual battle record; and the chat time length ratio is evaluated by using the interaction record evaluation model, to obtain an interaction score corresponding to the chat time length ratio.

The chat time length ratio is a ratio of a chat time length of the second user account and the first user account to a time length of the history virtual battle record.

In a possible implementation, when the second user account and a third user account are friends, and the third user account is placed into the reservation pool, the second user account is placed into the reservation pool by default together with the third user account.

In a possible implementation, when a followed user account agrees to participate in the second virtual battle, a following user account is placed into the reservation pool by default.

The followed user account is a user account that plays a leading role. The following user account is a user account that plays a following role.

For example, when a user account A agrees to participate in the second virtual battle, a user account B agrees to participate in the second virtual battle by default.

In a possible implementation, in a case that a quantity of user accounts that are of user accounts receiving next battle reservation invitation and that agree to participate in the second virtual battle is greater than a quantity threshold, the second user account is placed into the reservation pool by default.

In a possible implementation, when the second user account and the first user account are friends, the second user account is placed into the reservation pool by default.

In a possible implementation, when the second user account agrees to participate in the previous first virtual battle, the second user account is placed, by default, into the reservation pool corresponding to the second virtual battle.

In conclusion, according to the method provided in this aspect, the server receives the next battle reservation request sent by the first client, synchronizes the next battle reservation request to a client corresponding to at least one another user account in the first virtual battle, and feeds back, to the first client, information about a user account responding to the next battle reservation request. In this disclosure, a next virtual battle is reserved with a user account in the current battle on the battle interface of the current battle, thereby avoiding a settlement process, reducing usage time of an entire virtual battle, and improving efficiency of starting a virtual battle.

FIG. 18 is a flowchart of initiating reservation by a first client according to an aspect of this disclosure. The method may be performed by a first client, and a first user account is logged in on the first client. The method includes:

Operation 1801: Start.

Operation 1802: Initiate a next battle reservation request.

For example, the first client displays a battle interface corresponding to a first virtual battle, and the battle interface displays a next battle reservation control.

In response to a trigger operation performed on the next battle reservation control, the first client initiates the next battle reservation request to a client corresponding to another user account.

In some aspects, the first client sends the next battle reservation request to a server in response to the trigger operation performed on the next battle reservation control.

Operation 1803: The server synchronizes the next battle reservation request to another user account.

For example, the server receives the next battle reservation request sent by the first client, synchronizes the next battle reservation request to a client corresponding to another user account in the same team, and places the first user account into a reservation pool as the reservation initiator.

The reservation pool is configured for temporarily storing a user account that is in the same team and that agrees to participate in the second virtual battle.

Operation 1804: Display countdown in the reservation status control.

For example, a countdown identifier is further displayed on the battle interface. The first client displays the reservation status control with the first user account as the reservation initiator and displays the countdown identifier on the battle interface in response to a trigger operation performed on the next battle reservation control.

Display of the reservation status control with the first user account as the reservation initiator is canceled in a case that a display duration of the countdown identifier corresponding to the reservation status control reaches a time threshold.

Operation 1805: Switch the next battle reservation control to a reservation in-process control.

For example, the next battle reservation control is switched to the reservation in-process control on the battle interface in response to the trigger operation performed on the next battle reservation control.

The reservation in-process control is configured for ending or modifying the current reservation operation.

Operation 1806: End.

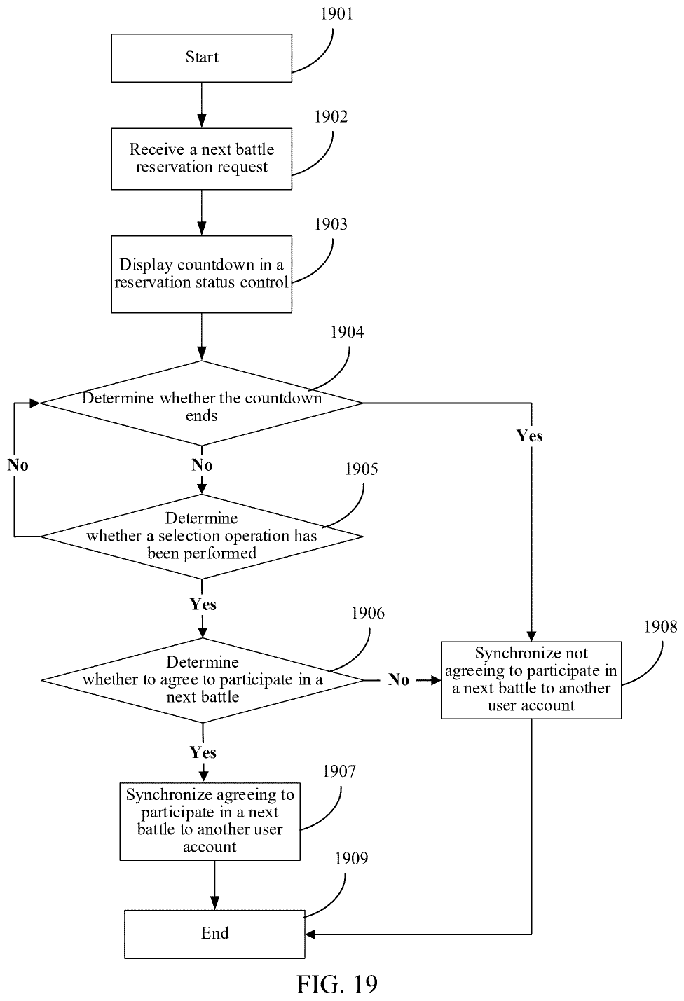

FIG. 19 is a flowchart of responding to reservation by a second client according to an aspect of this disclosure. The method may be performed by a client receiving reservation invitation. The method includes:

Operation 1901: Start.

Operation 1902: Receive a next battle reservation request.

For example, in response to a trigger operation performed on a next battle reservation control on a first client, the reservation status control is displayed on the second client corresponding to a user account receiving the next battle reservation request.

The reservation status control includes at least one reservation status indication identifier.

The reservation status indication identifier is used for indicating willingness representation of the user account to participate in the second virtual battle.

Operation 1903: Display countdown in the reservation status control.

For example, a countdown identifier is further displayed on a battle interface of the second client. The reservation status control with the first user account as the reservation initiator and the countdown identifier are displayed on the battle interface of the second client in response to a trigger operation performed on the next battle reservation control on the first client.

Display of the reservation status control with the first user account as the reservation initiator is canceled in a case that a display duration of the countdown identifier corresponding to the reservation status control reaches a time threshold.

Operation 1904: Determine whether the countdown ends.

In an example, a countdown identifier is correspondingly displayed in the reservation status control. It is determined whether the countdown ends. When a display duration of the countdown identifier reaches a time threshold, that is, when the countdown ends, operation 1908 is performed. When the display duration of the countdown identifier does not reach the time threshold, that is, when the countdown does not end, operation 1905 is performed.

Operation 1905: Determine whether a selection operation has been performed.

In an example, whether a user account on the second client has performed the selection operation is determined when the display duration of the countdown identifier does not reach the time threshold, and operation 1906 is performed when the user account on the second client has performed the selection operation. Operation 1904 is performed when the user account on the second client has not performed the selection operation.

Operation 1906: Determine whether to agree to participate in a next battle.

In an example, whether the user account on the second client agrees to participate in a next virtual battle is determined when the user account on the second client has performed the selection operation, and operation 1907 is performed when the user account on the second client agrees to participate in the next virtual battle. Operation 1908 is performed when the user account on the second client does not agree to participate in a next virtual battle.

Operation 1907: Synchronize agreeing to participate in a next battle to another user account.

In an example, when the user account on the second client agrees to participate in a next virtual battle, the server synchronizes, to another user account, information that the user account agrees to participate in the next virtual battle, so that the another user account knows.

Operation 1908: Synchronize not agreeing to participate in a next battle to another user account.

In an example, when the user account on the second client does not agree to participate in a next virtual battle, the server synchronizes, to another user account, information that the user account does not agree to participate in the next virtual battle, so that the another user account knows.

Operation 1909: End.

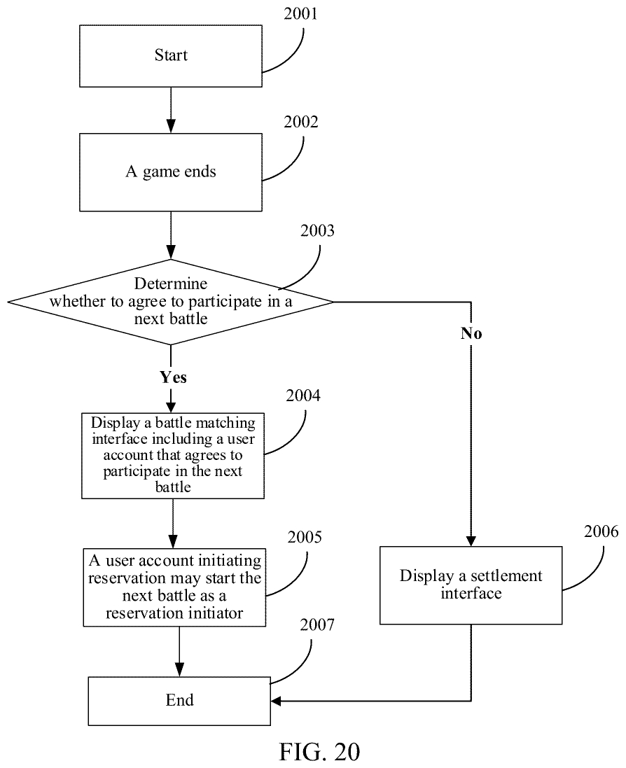

FIG. 20 is a flowchart of ending reservation according to an aspect of this disclosure. The method may be performed by a first client, and a first user account is logged in on the first client. The method includes:

Operation 2001: Start.

Operation 2002: A game ends.

For example, game ending means that a battle situation of a first virtual battle ends.

Operation 2003: Determine whether to agree to participate in a next battle.

In an example, the first client determines, after the first virtual battle ends, whether a user account receiving a next battle reservation request agrees to participate in a second virtual battle, performs operation 2004 when the user account receiving the next battle reservation request agrees to participate in the second virtual battle, and performs operation 2006 when the user account receiving the next battle reservation request does not agree to participate in the second virtual battle.

Operation 2004: Display a battle matching interface including the user account that agrees to participate in the next battle.

For example, when the user account receiving the next battle reservation request agrees to participate in the second virtual battle, the first client displays, after the first virtual battle ends, the battle matching interface of the second virtual battle including the user account that agrees to participate in the second virtual battle.

Operation 2005: A user account initiating reservation may start a next battle as a reservation initiator.

For example, on the battle matching interface including the user account that agrees to participate in the next battle, the user account initiating next battle reservation may directly start the next battle as a reservation initiator, thereby avoiding a settlement process, reducing usage time of an entire virtual battle, and improving efficiency of starting a virtual battle.

Operation 2006: Display a settlement interface.

For example, when the user account receiving the next battle reservation request does not agree to participate in the second virtual battle, the first client displays, after the first virtual battle ends, the settlement interface corresponding to the first virtual battle.

Operation 2007: End.

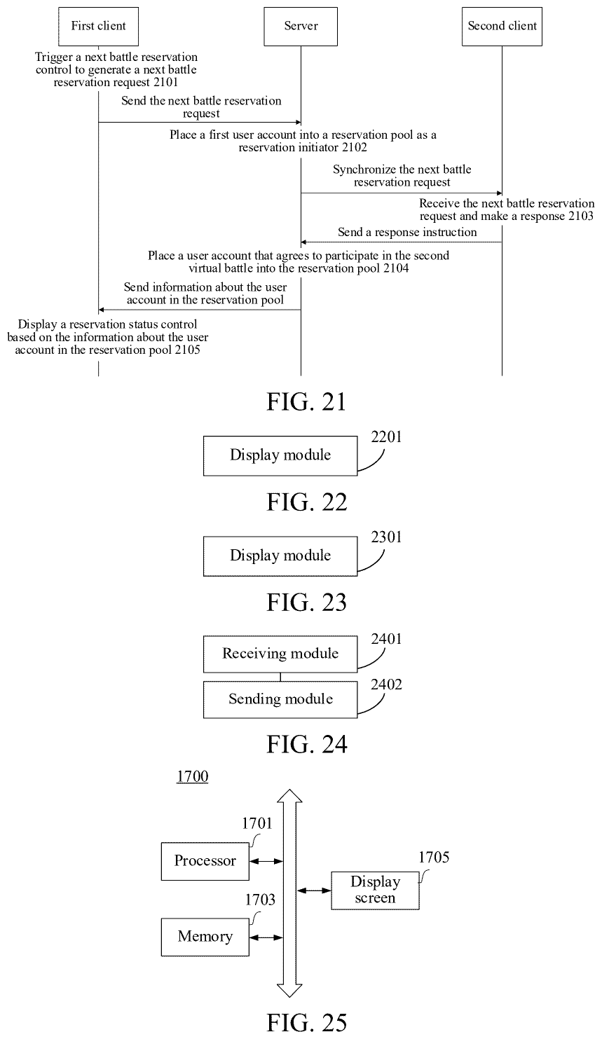

FIG. 21 is a flowchart of a virtual battle reservation method according to an aspect of this disclosure. The method includes:

Operation 2101: Trigger a next battle reservation control to generate a next battle reservation request.

For example, a battle interface of a first virtual battle is displayed on a first client, the next battle reservation control is displayed on the battle interface, and the virtual battle reservation request is generated on the first client by triggering the next battle reservation control. A first user account is logged in on the first client.

In some aspects, a manner of triggering the next battle reservation control includes at least one of single click, double click, triple click, tap, and long press, but is not limited thereto. This is not specifically limited in this aspect of this disclosure.

The next battle reservation control is a control (for example, a button) for reserving a second virtual battle with a user account in the first virtual battle.

In some aspects, there is at least one of reserving a next battle with an entire team in the first virtual battle through the next battle reservation control, or reserving a next battle with a user account that belongs to the same team in the first virtual battle through the next battle reservation control, or reserving a next battle with a user account that does not belong to the same team in the first virtual battle through the next battle reservation control, or reserving a next battle with a single person through the next battle reservation control, but this constitutes no limitation. This is not specifically limited in this aspect of this disclosure.

The next battle reservation request is used for inviting a user account in a first virtual battle to participate in a second virtual battle.

In some aspects, the next battle reservation request is obtained when a user account in the first virtual battle triggers a next battle reservation control on a corresponding client.

In some aspects, the next battle reservation request is at least one of, but is not limited to, reserving a next battle with a user account in the first virtual battle, reserving a next battle with a user account that belongs to the same team in the first virtual battle, and reserving a next battle with a user account that does not belong to the same team in the first virtual battle. This is not specifically limited in this aspect of this disclosure.

For example, the next battle reservation control includes an individual next battle reservation control. There is a one-to-one correspondence between the individual next battle reservation control and the user account.

In some aspects, the next battle reservation control is triggered on the first client to reserve a next battle with an entire team, with a user account that belongs to the same team, or with a user account that does not belong to the same team in the first virtual battle.

In some aspects, a next battle is reserved with an individual user account in the first virtual battle by triggering the individual next battle reservation control in the first client, to implement reservation in a specified manner.

In some aspects, a display form of the individual next battle reservation control is at least one of, but is not limited to, an avatar corresponding to an individual user account, a serial number corresponding to the individual user account, and character information corresponding to the individual user account. This is not specifically limited in this aspect of this disclosure.

Operation 2102: Place the first user account into a reservation pool as a reservation initiator.

For example, after the next battle reservation control is triggered to generate the next battle reservation request, the first client sends the next battle reservation request to a server. After receiving the next battle reservation request sent by the first client, the server synchronizes the next battle reservation request to a client corresponding to at least one user account in the first virtual battle, and places the first user account into the reservation pool as the reservation initiator.

The reservation pool is configured for temporarily storing a user account that is in the first virtual battle and that agrees to participate in the second virtual battle.

In some aspects, when the first user account on the first client is an initiating client that triggers the next battle reservation control in the same team, the next battle reservation request with the first user account as the reservation initiator is synchronized to the second client corresponding to the user account belonging to the same team.

In some aspects, when the first user account on the first client triggers the next battle reservation control in a specified manner, a specified next battle reservation request with the first user account as a reservation initiator is synchronized to the second client corresponding to the user account invited for reservation in a specified manner.

Operation 2103: Receive the next battle reservation request and make a response.

For example, after the second client receives the next battle reservation request synchronized by the server, the second client responds to the next battle reservation request. The second client sends a response instruction of the next battle reservation request to the server in response to a trigger operation on the second client that responds to the next battle reservation request.

The response instruction is used for indicating response representation of whether the user account on the second client participates in the second virtual battle.

The response instruction includes a first response instruction and a second response instruction.

In some aspects, the second client sends a first response instruction of the next battle reservation request to the server in response to a trigger operation on the second client that responds to the next battle reservation request.

The first response instruction is used for indicating response representation of whether the user account in the same team participates in the second virtual battle.

The first response instruction is used by the server to place the user account that is in the same team and that agrees to participate in the second virtual battle into the reservation pool.

In some aspects, the second client sends a second response instruction of the specified next battle reservation request to the server in response to a trigger operation on the second client that responds to the specified next battle reservation request.

The second response instruction is used for indicating response representation of whether the user account invited for reservation in a specified manner participates in the second virtual battle.

The second response instruction is used by the server to place the user account that is of the user accounts invited for reservation in a specified manner and that agrees to participate in the second virtual battle into the reservation pool.

Operation 2104: Place the user account that agrees to participate in the second virtual battle into the reservation pool.

For example, after receiving the response instruction, when the user account on the second client agrees to participate in the second virtual battle, the server places the user account that agrees to participate in the second virtual battle into the reservation pool.

The server sends user account information in the reservation pool to the first client.

In some aspects, after receiving the first response instruction, the server places a user account that is of user accounts belonging to the same team and that agrees to participate in the second virtual battle into the reservation pool.

In some aspects, after receiving the second response instruction, the server places the user account that is of the user accounts invited for reservation in a specified manner and that agrees to participate in the second virtual battle into the reservation pool.

Operation 2105: Display a reservation status control based on user account information in the reservation pool.

For example, after the first client receives the user account information in the reservation pool sent by the server, the first client displays the reservation status control based on the user account information in the reservation pool.

The reservation status control includes at least one reservation status indication identifier.

The reservation status indication identifier is used for indicating willingness representation of the user account to participate in the second virtual battle. There is a one-to-one correspondence between the reservation status indication identifier and the user account.

In some aspects, a form of the reservation status indication identifier is at least one of an avatar of a virtual character corresponding to a user account, an identifier of a user account, a color box, and a shadow image, but is not limited thereto. This is not specifically limited in this aspect of this disclosure.

For example, the reservation status indication identifier is a color box. After the first client receives the user account information in the reservation pool sent by the server, when the user account agrees to participate in the second virtual battle, a color box corresponding to each user account is displayed in red. When the user account does not agree to participate in the second virtual battle, a color box corresponding to each user account is displayed in a default color (colorless).

FIG. 22 is a schematic structural diagram of a virtual battle reservation apparatus according to an aspect of this disclosure. The apparatus may be implemented as an entire first client or a part of the first client by using software, hardware, or a combination thereof. The apparatus includes:

a display module 2201, configured to display a battle interface corresponding to a first virtual battle; a next battle reservation control being displayed on the battle interface, and the next battle reservation control being a control (for example, a button) for reserving a second virtual battle for a user account in the first virtual battle.

The display module 2201 is further configured to display a reservation status control on the battle interface in response to a trigger operation performed on the next battle reservation control; the reservation status control including at least one reservation status indication identifier, and the reservation status indication identifier being used for indicating willingness representation of a user account to participate in the second virtual battle; there being a one-to-one correspondence between the reservation status indication identifier and the user account; and the second virtual battle being behind the first virtual battle.

The display module 2201 is further configured to display, after the first virtual battle ends, a battle matching interface corresponding to the second virtual battle including the first user account and a second user account. The second user account is a user account that is in the first virtual battle and that agrees to participate in the second virtual battle. In other words, the second user account is a user account that is in the first virtual battle and whose corresponding reservation status indication identifier indicates agreeing to participate in the second virtual battle, and the battle matching interface is used by the first user account and the second user account to participate in the second virtual battle.

In a possible implementation, the display module 2201 is configured to display, in response to the trigger operation performed on the next battle reservation control, the reservation status control with the first user account as a reservation initiator in a case that the first user account is an initiating account that triggers the next battle reservation control.

In a possible implementation, the display module 2201 is configured to display, in the reservation status control with the first user account as the reservation initiator in response to the trigger operation performed on the next battle reservation control and in the case that the first user account is an initiating account that triggers the next battle reservation control in the same team, a reservation status indication identifier corresponding to a user account that is in the same team and that agrees to participate in the second virtual battle.

In a possible implementation, the display module 2201 is configured to send a next battle reservation request to a server in response to the trigger operation performed on the next battle reservation control; where the server is configured to synchronize the next battle reservation request to a client corresponding to another user account in the same team, and place the first user account into a reservation pool as the reservation initiator; and the reservation pool is configured for temporarily storing a user account that is in the first virtual battle and that agrees to participate in the second virtual battle; and display, in the reservation status control based on information about the user account in the reservation pool that is fed back by the server, the reservation status indication identifier corresponding to the user account that is in the same team and that agrees to participate in the second virtual battle.

In a possible implementation, the display module 2201 is configured to display, in the reservation status control in response to the trigger operation performed on the next battle reservation control and in a case that the first user account triggers the next battle reservation control in a specified manner, a reservation status indication identifier corresponding to a user account that is of user accounts invited for reservation in a specified manner and that agrees to participate in the second virtual battle.

In a possible implementation, the display module 2201 is configured to send a specified next battle reservation request to the server in response to the specified trigger operation performed on the next battle reservation control; where the server is configured to synchronize the specified next battle reservation request to a client corresponding to a user account invited for reservation in a specified manner in the first virtual battle, and place the first user account into a reservation pool as the reservation initiator; and the reservation pool is configured for temporarily storing a user account that is in the first virtual battle and that agrees to participate in the second virtual battle; and display, in the reservation status control based on information about the user account in the reservation pool that is fed back by the server, the reservation status indication identifier corresponding to the user account that is of the user accounts invited for reservation in a specified manner and that agrees to participate in the second virtual battle.

In a possible implementation, the next battle reservation control further includes an individual next battle reservation control; and the display module 2201 is configured to send a specified next battle reservation request to the server in response to a specified trigger operation performed on the individual next battle reservation control. The specified next battle reservation request is configured for requesting a user account corresponding to the individual next battle reservation control to participate in the second virtual battle; and the server is configured to synchronize the specified next battle reservation request to the client corresponding to the user account invited for reservation in a specified manner in the first virtual battle.

In a possible implementation, the display module 2201 is further configured to dynamically display, in the reservation status control in response to the trigger operation performed on the next battle reservation control, the reservation status indication identifier corresponding to the user account that agrees to participate in the second virtual battle.

In a possible implementation, the display module 2201 is further configured to cancel display of the reservation status control with the first user account as the reservation initiator in a case that the reservation status control satisfies a display cancellation condition.

In a possible implementation, the display module 2201 is configured to cancel display of the reservation status control with the first user account as the reservation initiator in a case that all user accounts receiving next battle reservation invitation agree to participate in the second virtual battle.

In a possible implementation, the display module 2201 is configured to cancel display of the reservation status control with the first user account as the reservation initiator in a case that at least one user account receiving next battle reservation invitation does not agree to participate in the second virtual battle and a display duration of the reservation status control reaches a time threshold.

In a possible implementation, the battle interface further displays a reservation in-process control; and the display module 2201 is further configured to switch the next battle reservation control to the reservation in-process control on the battle interface in response to the trigger operation performed on the next battle reservation control. The reservation in-process control is configured for ending or modifying the current reservation operation.

In a possible implementation, the display module 2201 is configured to display, after the first virtual battle ends and in a case that the reservation operation for the second virtual battle succeeds, the battle matching interface corresponding to the second virtual battle including the first user account and the second user account.

In a possible implementation, the display module 2201 is configured to display, after the first virtual battle ends and in a case that a quantity of user accounts that agree to participate in the second virtual battle is greater than a quantity threshold, the battle matching interface corresponding to the second virtual battle including the first user account and the second user account.

In a possible implementation, the display module 2201 is further configured to display a battle settlement interface of the first virtual battle after the first virtual battle ends and in a case that the reservation operation for the second virtual battle fails.

FIG. 23 is a schematic structural diagram of a virtual battle reservation apparatus according to an aspect of this disclosure. The apparatus may be implemented as an entire second client or a part of the second client by using software, hardware, or a combination thereof. The apparatus includes:

a display module 2301, configured to display a battle interface corresponding to a first virtual battle.

The display module 2301 is further configured to display a reservation status control on the battle interface on the second client, the reservation status control including at least one reservation status indication identifier, and the reservation status indication identifier being used for indicating willingness representation of a user account to participate in the second virtual battle, there being a one-to-one correspondence between the reservation status indication identifier and the user account, and the second virtual battle being behind the first virtual battle.

The display module 2301 is further configured to display, after the first virtual battle ends, a battle matching interface corresponding to the second virtual battle including the first user account and a second user account. The second user account is a user account that is in the first virtual battle and that agrees to participate in the second virtual battle. In other words, the second user account is a user account that is in the first virtual battle and whose corresponding reservation status indication identifier indicates agreeing to participate in the second virtual battle, and the battle matching interface is used by the first user account and the second user account to participate in the second virtual battle.

In a possible implementation, the display module 2301 is configured to display the reservation status control with the first user account as a reservation initiator on the second client. The first user account is logged in on a first client. The first user account as the reservation initiator is determined when the first user account is an initiating account that triggers the next battle reservation control.

In a possible implementation, the display module 2301 is configured to display, in the reservation status control with the first user account as the reservation initiator on the second client, a reservation status indication identifier corresponding to a user account that is in the same team and that agrees to participate in the second virtual battle.

In a possible implementation, the display module 2301 is configured to receive a next battle reservation request synchronized by a server; where the next battle reservation request is generated after the next battle reservation control on the first client is triggered; the server is configured to synchronize the next battle reservation request on the first client to a client corresponding to another user account in the same team, and place the first user account into a reservation pool as the reservation initiator; and the reservation pool is configured for temporarily storing a user account that is in the first virtual battle and that agrees to participate in the second virtual battle; send a first response instruction of the next battle reservation request to the server in response to a trigger operation on the second client that responds to the next battle reservation request; where the first response instruction is used for indicating response representation of whether the user account in the same team participates in the second virtual battle; and the first response instruction is used by the server to place the user account that is in the same team and that agrees to participate in the second virtual battle into the reservation pool; and display, in the reservation status control on the second client based on information about the user account in the reservation pool that is fed back by the server, the reservation status indication identifier corresponding to the user account that is in the same team and that agrees to participate in the second virtual battle.

In a possible implementation, the display module 2301 is configured to display, in the reservation status control on the second client, a reservation status indication identifier corresponding to a user account that is of user accounts invited for reservation in a specified manner and that agrees to participate in the second virtual battle; where

inviting in reservation in a specified manner is an operation of inviting a specified user account to a next battle on the first client.

In a possible implementation, the next battle reservation control further includes an individual next battle reservation control; there is a one-to-one correspondence between the individual next battle reservation control and the user account; and the display module 2301 is configured to receive a specified next battle reservation request synchronized by a server; where the specified next battle reservation request is generated after the individual next battle reservation control on the first client is triggered; the server is configured to synchronize the specified next battle reservation request on the first client to a client corresponding to a user account invited for reservation in a specified manner in the first virtual battle, and place the first user account into the reservation pool as the reservation initiator; and the reservation pool is configured for temporarily storing a user account that is in the first virtual battle and that agrees to participate in the second virtual battle; send a second response instruction of the specified next battle reservation request to the server in response to a trigger operation on the second client that responds to the specified next battle reservation request; where the second response instruction is used for indicating response representation of whether the user account invited for reservation in a specified manner participates in the second virtual battle; and the second response instruction is used by the server to place the user account that is of the user accounts invited for reservation in a specified manner and that agrees to participate in the second virtual battle into the reservation pool; and display, in the reservation status control on the second client based on information about the user account in the reservation pool that is fed back by the server, the reservation status indication identifier corresponding to the user account that is of the user accounts invited for reservation in a specified manner and that agrees to participate in the second virtual battle.

In a possible implementation, the display module 2301 is further configured to dynamically display, in the reservation status control, the reservation status indication identifier corresponding to the user account that agrees to participate in the second virtual battle.

In a possible implementation, the display module 2301 is further configured to cancel display of the reservation status control with the first user account as the reservation initiator on the second client in a case that the reservation status control satisfies a display cancellation condition.

In a possible implementation, the display module 2301 is configured to cancel display of the reservation status control with the first user account as the reservation initiator on the second client in a case that all user accounts receiving next battle reservation invitation agree to participate in the second virtual battle.

In a possible implementation, the display module 2301 is configured to cancel display of the reservation status control with the first user account as the reservation initiator on the second client in a case that at least one user account receiving next battle reservation invitation does not agree to participate in the second virtual battle and a display duration of the reservation status control reaches a time threshold.

In a possible implementation, the display module 2301 is configured to directly display, after the first virtual battle ends and in a case that the reservation operation for the second virtual battle succeeds, the battle matching interface corresponding to the second virtual battle including the first user account and the second user account.

In a possible implementation, the display module 2301 is configured to directly display, after the first virtual battle ends and in a case that a quantity of user accounts that agree to participate in the second virtual battle is greater than a quantity threshold, the battle matching interface corresponding to the second virtual battle including the first user account and the second user account.

In a possible implementation, the display module 2301 is further configured to display a battle settlement interface of the first virtual battle after the first virtual battle ends and in a case that the reservation operation for the second virtual battle fails.

FIG. 24 is a schematic structural diagram of a virtual battle reservation apparatus according to an aspect of this disclosure. The apparatus may be implemented as an entire server or a part of the server by using software, hardware, or a combination thereof. The apparatus includes:

a receiving module 2401, configured to receive a next battle reservation request transmitted by a first client; the next battle reservation request being used for inviting a user account in a first virtual battle to participate in a second virtual battle; and

a transmission module 2402, configured to synchronize the next battle reservation request to a client corresponding to at least one another user account in the first virtual battle. The second virtual battle is behind the first virtual battle.

The transmission module 2402 is further configured to feed back, to the first client, information about a user account responding to the next battle reservation request.

In a possible implementation, the transmission module 2402 is configured to synchronize, in a case that the first client is an initiating client that transmits the next battle reservation request, the next battle reservation request with the first user account corresponding to the first client as a reservation initiator to the client corresponding to the at least one another user account in the first virtual battle.

In a possible implementation, the transmission module 2402 is configured to synchronize, in a case that the first client is an initiating client that transmits the next battle reservation request in the same team, the next battle reservation request to a client corresponding to another user account in the same team, and place the first user account into a reservation pool as the reservation initiator; where the reservation pool is configured for temporarily storing a user account that is in the first virtual battle and that agrees to participate in the second virtual battle; and send, to the first client, user account information corresponding to a user account that is in the same team in the reservation pool and that agrees to participate in the second virtual battle.

In a possible implementation, the transmission module 2402 is configured to synchronize, in a case that the first client is an initiating client that transmits a specified next battle reservation request, the specified next battle reservation request to a client corresponding to a user account invited for reservation in a specified manner, and place the first user account into a reservation pool as the reservation initiator; and send, to the first client, user account information corresponding to a user account that is of user accounts invited for reservation in a specified manner and that is in the reservation pool and agrees to participate in the second virtual battle.

In a possible implementation, the transmission module 2402 is further configured to send, to the first client in a case that the reservation status control satisfies a display cancellation condition, an instruction of canceling display of the reservation status control.

In a possible implementation, the transmission module 2402 is configured to send, to the first client in a case that all user accounts receiving next battle reservation invitation agree to participate in the second virtual battle, the instruction of canceling display of the reservation status control.

In a possible implementation, the transmission module 2402 is configured to send, to the first client in a case that at least one user account receiving next battle reservation invitation does not agree to participate in the second virtual battle and a display duration of the reservation status control reaches a time threshold, the instruction of canceling display of the reservation status control.

When the apparatuses shown in FIG. 22 to FIG. 24 implement functions thereof, beneficial effects thereof are the same as those of the foregoing method aspects, and details are not described herein again. When the apparatuses shown in FIG. 22 to FIG. 24 implement functions thereof, only division of the foregoing functional modules is used as an example for description. In an actual application, the functions may be allocated to and completed by different functional modules according to requirements. That is, an internal structure of the device is divided into different functional modules, to complete all or some of the functions described above. In addition, the apparatus provided in the foregoing aspects and the method aspects belong to the same concept. For details of a specific implementation process, reference may be made to the method aspects. Details are not described herein again.

FIG. 25 is a structural block diagram of a computer device 1700 according to an aspect of this disclosure. The computer device 1700 can be a portable mobile terminal, for example, a smartphone, a tablet computer, a moving picture experts group audio layer III (MP3) player, or a moving picture experts group audio layer IV (MP4) player. The computer device 1700 may also be called a user device, a portable terminal, or other names.

The computer device 1700 includes: processing circuitry (for example, a processor 1701 and a memory 1703 (for example, a non-transitory computer-readable storage medium).

The processor 1701 may include one or more processing cores, for example, a 4-core processor or an 8-core processor. The processor 1701 may be implemented in at least one hardware form of a digital signal processor (DSP), a field-programmable gate array (FPGA), and a programmable logic array (PLA). The processor 1701 may also include a main processor and a co-processor. The main processor is a processor configured to process data in an awake state, and is also referred to as a central processing unit (CPU). The co-processor is a processor with low power consumption configured to process data in a standby state. In some aspects, the processor 1701 may be integrated with a graphics processing unit (GPU). The GPU is configured to render and draw content that needs to be displayed on a display screen. In some aspects, the processor 1701 may further include an artificial intelligence (AI) processor. The AI processor is configured to process computing operations related to machine learning.

The memory 1703 may include one or more non-transitory computer-readable storage media. The non-transitory computer-readable storage medium may be tangible and non-volatile (that is, non-transitory). The memory 1703 may further include a high-speed random access memory and a nonvolatile memory, for example, one or more disk storage devices or flash storage devices. In some aspects, the non-transitory computer-readable storage medium in the memory 1703 is configured to store at least one instruction, and the at least one instruction is configured to be executed by the processor 1701 to implement the virtual battle reservation method provided in the aspects of this disclosure.

In some aspects, the computer device 1700 further includes: a display screen 1705, configured to display a user interface (UI). The UI may include a graph, a text, an icon, a video, and any combination thereof. The display screen 1705 further has a capability of acquiring a touch signal on or above a surface of the display screen 1705. The touch signal may be inputted to the processor 1701 as a control signal for processing. The display screen 1705 is configured to provide a virtual button and/or a virtual keyboard that are/is also referred to as a soft button and/or a soft keyboard. In some aspects, there may be one display screen 1705, disposed on a front panel of the computer device 1700. In some other aspects, there may be at least two display screens 1705, disposed on different surfaces of the computer device 1700 respectively or in a folded design. In still other aspects, the display screen 1705 may be a flexible display screen, disposed on a curved surface or a folded surface of the computer device 1700. Even, the display screen 1705 may be further set in a non-rectangular irregular pattern, namely, a special-shaped screen. The display screen 1705 may be manufactured by using a material such as a liquid crystal display (LCD) or an organic light-emitting diode (OLED).

A person skilled in the art may understand that the structure shown in FIG. 25 constitutes no limitation on the computer device 1700, and the computer device may include more or fewer components than those shown in the figure, or some components may be combined, or a different component deployment may be used.

An aspect of this disclosure further provides a computer device. The computer device includes a processor and a memory, the memory having at least one program stored therein, the at least one program being loaded and executed by the processor to implement the virtual battle reservation method provided in the foregoing method aspects.

An aspect of this disclosure further provides a non-transitory computer-readable storage medium, storing at least one computer program, and the at least one computer program being loaded and executed by a processor to implement the virtual battle reservation method according to the foregoing method aspects.

An aspect of this disclosure further provides a computer program product, including computer programs, and the computer programs being stored in a non-transitory computer-readable storage medium. The computer program is read and executed by a processor of a computer device from the non-transitory computer-readable storage medium, so that the computer device implements the virtual battle reservation method according to the foregoing method aspects.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

“Plurality of” mentioned in the specification means two or more. “And/or” describes an association relationship between associated objects, and represents that there may be three relationships. For example, A and/or B may represent three cases: only A exists, both A and B exist, and only B exists. The character “/” indicates an “or” relationship between the associated objects.

A person of ordinary skill in the art may understand that all or some of the operations of the foregoing aspects may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely examples of aspects of this disclosure, and are not intended to limit this disclosure. Any modification, equivalent replacement, or improvement made within the spirit and principle of this disclosure shall fall within the scope of this disclosure.

What is claimed is:

1. A virtual game reservation method, comprising:
displaying a gaming interface corresponding to a first virtual game session that includes a plurality of users, the gaming interface including a game reservation control element;
based on a user selection of the game reservation control element in the gaming interface by a first user of the plurality of users, displaying a reservation status control interface on the gaming interface, the reservation status control interface including a reservation status indication identifier for each of a subset of the plurality of users, the reservation status indication identifier of each of the subset of the plurality of users indicating whether the respective user intends to participate in a second virtual game session; and
after the first virtual game session has ended, displaying a game matching interface corresponding to the second virtual game session, the game matching interface identifying each of the subset of the plurality of users of the first virtual game session that indicated intent to participate in the second virtual game session.

2. The method according to claim 1, wherein the displaying the reservation status control interface on the gaming interface comprises:
displaying the reservation status control interface with the first user designated as a reservation initiator based on the first user being first among the plurality of users to initiate a game session reservation function for the second virtual game session.

3. The method according to claim 1, wherein
when a game session reservation function associated with the reservation status control interface is for a same team, the subset of the plurality of users includes at least one other user in the same team.

4. The method according to claim 3, further comprising:
transmitting at least one game reservation request to a server based on the user selection of the game reservation control element by the first user, wherein the server is configured to:
provide the at least one game reservation request to at least one client corresponding to the at least one other user in the same team, and
store first user information associated with the first user in a reservation pool, the reservation pool being configured to temporarily store user information associated with any user in the first virtual game session who has indicated the intent to participate in the second virtual game session; and
displaying, in the reservation status control interface, the reservation status indication identifier corresponding to each of the at least one other user in the same team based on reservation information from the reservation pool indicating participation in the second virtual game session.

5. The method according to claim 1, further comprising:
receiving an indication of which of the plurality of users to include in the subset of the plurality of users from the first user.

6. The method according to claim 5, further comprising:
transmitting a targeted user game reservation request to a server, wherein the server is configured to:
provide the targeted user game reservation request to each of the subset of the plurality of users, and
store first user information associated with the first user in a reservation pool, the reservation pool being configured to temporarily store user information of each of the subset of the plurality of users in the first virtual game session that indicated the intent to participate in the second virtual game session; and
displaying, in the reservation status control interface, the reservation status indication identifier corresponding to each of the subset of the plurality of users based on information from the reservation pool indicating the intent to participate in the second virtual game session.

7. The method according to claim 6, wherein
the game reservation control element includes a targeted game reservation control element corresponding to each of the subset of the plurality of users.

8. The method according to claim 7, further comprising:
dynamically displaying, in the reservation status control interface, a plurality of reservation status indication identifiers corresponding to each user that intends to participate in the second virtual game session.

9. The method according to claim 8, further comprising:
canceling display of the reservation status control interface when a display cancellation condition is satisfied.

10. The method according to claim 9, wherein the display cancellation condition is satisfied when each of the subset of the plurality of users has indicated whether the respective user intends to participate in the second virtual game session.

11. The method according to claim 9, wherein the display cancellation condition is satisfied when at least one user from subset of the plurality of users indicates intent to not participate in the second virtual game session and a display duration of the reservation status control interface reaches a time threshold.

12. The method according to claim 9, wherein the gaming interface further displays a reservation in-process control element, and the method further comprises:
switching display from the game reservation control element to the reservation in-process control element on the gaming interface when the game reservation control element is selected, the reservation in-process control element being configured to end or modify at least one game reservation request.

13. The method according to claim 1, wherein the displaying the game matching interface corresponding to the second virtual game session comprises:
after the first virtual game session has ended and at least one of the subset of the plurality of users indicates the intent to participate in the second virtual game session, displaying the game matching interface corresponding to the second virtual game session that includes the first user and the at least one of the subset of the plurality of users to indicated the intent to participate in the second virtual game session.

14. The method according to claim 13, wherein the displaying the game matching interface corresponding to the second virtual game session comprises:
after the first virtual game session has ended and when detecting a quantity of the subset of the plurality of users that indicated the intent to participate in the second virtual game session is greater than a quantity threshold, displaying the game matching interface corresponding to the second virtual game session that includes the first user and the subset of the plurality of users that indicated the intent to participate in the second virtual game session.

15. The method according to claim 13, further comprising:
displaying a game settlement interface for the first virtual game session after the first virtual game session has ended and when a game reservation request for the second virtual game session associated with the user selection of the game reservation control element fails.

16. A non-transitory computer-readable storage medium storing instructions which, when executed by a processor, cause the processor to perform:
displaying a gaming interface corresponding to a first virtual game session that includes a plurality of users, the gaming interface including a game reservation control element;
based on a user selection of the game reservation control element in the gaming interface by a first user of the plurality of users, displaying a reservation status control interface on the gaming interface, the reservation status control interface including a reservation status indication identifier for each of a subset of the plurality of users, the reservation status indication identifier of each of the subset of the plurality of users indicating whether the respective user intends to participate in a second virtual game session; and
after the first virtual game session has ended, displaying a game matching interface corresponding to the second virtual game session, the game matching interface identifying each of the subset of the plurality of users of the first virtual game session that indicated intent to participate in the second virtual game session.

17. The non-transitory computer-readable storage medium according to claim 16, wherein the displaying the reservation status control interface on the gaming interface comprises:
displaying the reservation status control interface with the first user designated as a reservation initiator based on the first user being first among the plurality of users to initiate a game session reservation function for the second virtual game session.

18. The non-transitory computer-readable storage medium according to claim 17, wherein when a game session reservation function associated with the reservation status control interface is for a same team, the subset of the plurality of users includes at least one other user in the same team.

19. The non-transitory computer-readable storage medium according to claim 18, further comprising:
transmitting at least one game reservation request to a server based on the user selection of the game reservation control element by the first user, wherein the server is configured to:
provide the at least one game reservation request to at least one client corresponding to the at least one other user in the same team, and
store first user information associated with the first user in a reservation pool, the reservation pool being configured to temporarily store user information associated with any user in the first virtual game session who has indicated the intent to participate in the second virtual game session; and
displaying, in the reservation status control interface, the reservation status indication identifier corresponding to each of the at least one other user in the same team based on reservation information from the reservation pool indicating participation in the second virtual game session.

20. A virtual game reservation apparatus, comprising:
processing circuitry configured to:
display a gaming interface corresponding to a first virtual game session that includes a plurality of users, the gaming interface including a game reservation control element;
based on a user selection of the game reservation control element in the gaming interface by a first user of the plurality of users, display a reservation status control interface on the gaming interface, the reservation status control interface including a reservation status indication identifier for each of a subset of the plurality of users, the reservation status indication identifier of each of the subset of the plurality of users indicating whether the respective user intends to participate in a second virtual game session; and
after the first virtual game session has ended, display a game matching interface corresponding to the second virtual game session, the game matching interface identifying each of the subset of the plurality of users of the first virtual game session that indicated intent to participate in the second virtual game session.
